(19) United States
(12) Patent Application Publication
(10) Pub. No.: US 2025/0106655 A1
(43) Pub. Date: Mar. 27, 2025

(54) NETWORK NODE AND METHOD PERFORMED BY THE SAME AND STORAGE MEDIUM

(71) Applicant: Samsung Electronics Co., Ltd., Suwon-si (KR)

(72) Inventors: Huan HE, Beijing (CN); Zhining YIN, Beijing (CN); Yinghuan ZHAO, Beijing (CN); Yan LI, Beijing (CN); Huiyang WANG, Beijing (CN); Jiajia WANG, Beijing (CN)

(21) Appl. No.: 18/901,681

(22) Filed: Sep. 30, 2024

Related U.S. Application Data
(63) Continuation of application No. PCT/KR2024/011450, filed on Aug. 2, 2024.

(30) Foreign Application Priority Data
Sep. 27, 2023 (CN) 202311264914.4

(51) Int. Cl. H04W 24/02; H04W 56/00

(52) U.S. Cl. CPC H04W 24/02; H04W 56/0045

(57) ABSTRACT

Embodiments of the present disclosure provide a network node and a method performed by the network node and a storage medium, relating to a field of artificial intelligence. A method performed by a network node may comprise: detecting an overshooting cell; determining an adjustment step corresponding to the overshooting cell based on a coverage situation of the overshooting cell; and adjusting a coverage range of the overshooting cell based on the determined adjustment step. The method performed by the network node may be performed using an artificial intelligence model.

### CROSS-REFERENCE TO RELATED APPLICATIONS

This application is a continuation of International Application No. PCT/KR2024/011450 designating the United States, filed on Aug. 2, 2024, in the Korean Intellectual Property Receiving Office and claiming priority to Chinese Patent Application No. 202311264914.4, filed on Sep. 27, 2023, in the Chinese Patent Office, the disclosures of each of which are incorporated by reference herein in their entireties.

### BACKGROUND

### Field

The present disclosure relates to the field of communication and for example, to a network node, a method performed by the network node, and a computer-readable storage medium.

### Description of Related Art

In the field of communication, it may occur that the signal of a cell appears outside the coverage range of this cell, for example, if the signal of a cell appears outside the coverage range of this cell due to the antenna height of the base station being too high or the down-tilt angle being too small and the cell is able to become a primary service cell, this cell may be referred to as an overshooting cell. Overshooting tends to occur in hilly terrain or along regions on two sides of roads or harbors. Overshooting results in too many users in the current cell and a drop in the rate per user, which may result in call blocking if the cell is fully loaded with users. Further, if the signal of an overshooting cell appears in a region apart from its neighbor cells and the cell becomes the primary service cell, then the “island effect” will occur, and the island effect will lead to call drops during the user's movement. In the prior art, when an overshooting cell is detected, the coverage range of each overshooting cell is adjusted based on a pre-set uniform fixed step for all overshooting cells, which, however, fails to meet the differentiated needs of different scenarios.

The above information is presented as background information only to assist with an understanding of the disclosure. No determination has been made, and no assertion is made, as to whether any of the above might be applicable as prior art with regard to the disclosure.

### SUMMARY

According to an example embodiment of the present disclosure, a method performed by a network node is provided, comprising: detecting an overshooting cell; determining an adjustment step corresponding to the overshooting cell based on a coverage situation of the overshooting cell; and adjusting a coverage range of the overshooting cell based on the determined adjustment step.

The detecting of the overshooting cell may include: acquiring real-time transmission environment information of a cell; and determining whether the cell is the overshooting cell based on the real-time transmission environment information of the cell.

The acquiring of the real-time transmission environment information of the cell may include: acquiring cell-related data and/or user-related data; and acquiring the real-time transmission environment information of the cell based on the cell-related data and/or the user-related data.

The acquiring of the real-time transmission environmental information of the cell based on the cell-related data and/or the user-related data may include: acquiring a current user location distribution and a current timing advance (TA) distribution of the cell based on the cell-related data and/or the user-related data; and acquiring the real-time transmission environment information of the cell according to the current user location distribution and the current TA distribution.

The cell-related data comprises at least one of cell configuration information and cell historical TA data; and/or the user-related data comprises measurement information reported by a served user in the cell.

The acquiring of the current user location distribution and the current timing advance (TA) distribution based on the cell-related data and the user-related data may include: predicting, using a first artificial intelligence network, a historical user location distribution of the cell based on the user-related data and the cell configuration information, and predicting, using a second artificial intelligence network, the current user location distribution based on the historical user location distribution; and predicting, using a third artificial intelligence network, the current TA distribution based on the cell historical TA data.

The real-time transmission environment information represents a ratio of line-of-sight (LOS) transmissions and non-line-of-sight (NLOS) transmissions in the cell.

The determining of whether the cell is the overshooting cell based on the real-time transmission environment information of the cell may include: obtaining an actual coverage range of the cell based on a current user location distribution of the cell; obtaining a planned coverage range of the cell based on the real-time transmission environment information; and determining whether the cell is the overshooting cell according to the actual coverage range of the cell and the planned coverage range of the cell.

The obtaining of the planned coverage range of the cell based on the real-time transmission environmental information may include: determining a theoretical coverage range of the cell based on cell related data; and predicting, using a fourth artificial intelligence network, the planned coverage range based on the real-time transmission environmental information and the theoretical coverage range of the cell.

The determining of the adjustment step corresponding to the overshooting cell based on the coverage situation of the overshooting cell may include: determining the adjustment step corresponding to the overshooting cell according to an actual coverage range and a planned coverage range of the overshooting cell.

The determining of the adjustment step corresponding to the overshooting cell based on the coverage situation of the overshooting cell may include: constructing a cell group according to related information between cells, wherein the cell group comprises the overshooting cell; and determining the adjustment step corresponding to the overshooting cell according to overshooting related information between the overshooting cell and other cells in the cell group.

The related information between the cells comprises at least one of neighbor cell information, handover information, interference information.

The constructing of the cell group according to the related information between the cells may include: determining relationship intimacy degree between a plurality of cells comprising the overshooting cell according to the related information between the cells, wherein the relationship intimacy degree represents an influence degree between the cells; and constructing the cell group based on the acquired relationship intimacy degree.

The determining of the relationship intimacy degree between the plurality of cells comprising the overshooting cell according to the related information between the cells may include: determining, using a fifth artificial intelligence network, the relationship intimacy degree between the plurality of cells comprising the overshooting cell according to the related information between the cells.

The constructing of the cell group based on the acquired relationship intimacy degree may include: determining an overshooting level of each cell according to an actual coverage range and a planned coverage range of each cell among the plurality of cells; and constructing the cell group based on the determined overshooting level and the acquired relationship intimacy degree.

The determining of the overshooting level of each cell according to the actual coverage range and the planned coverage range of each cell among the plurality of cells may include: predicting, using a sixth artificial intelligence network, the overshooting level of each cell according to the actual coverage range and the planned coverage range of each cell.

The constructing of the cell group based on the determined overshooting level and the acquired relationship intimacy degree may include: performing a following operation for each overshooting cell in turn according to the overshooting level; and selecting at least one cell from the other cells to form the cell group with the overshooting cell based on the relationship intimacy degree between the overshooting cell and the other cells.

The overshooting related information comprises: relationship intimacy degree and/or an overlap coverage ratio.

The method may further comprise: acquiring measurement information of the overshooting cell and at least one other cell in the cell group; and determining the overlap coverage ratio between the overshooting cell and the at least one other cell in the cell group according to the measurement information.

The determining of the overlap coverage ratio between the overshooting cell and the at least one other cell in the cell group according to the measurement information may include: determining a measurement information difference value of a served user between the overshooting cell and the at least one other cell in the cell group according to the measurement information; determining a number of overlap areas between the overshooting cell and the at least one other cell in the cell group according to a comparison of the measurement information difference value with a set threshold; and determining the overlap coverage ratio between the overshooting cell and the at least one other cell in the cell group according to the number of the overlap areas between the overshooting cell and the at least one other cell in the cell group and a number of the measurement information.

The measurement information comprises reference signal receiving power RSRP.

The determining of the adjustment step corresponding to the overshooting cell may include: determining a first cell most affected by overshooting of the overshooting cell from the cell group; and determining the adjustment step corresponding to the overshooting cell according to the cell relationship intimacy degree and the overlap coverage ratio between the overshooting cell and the first cell.

The determining of the first cell most affected by the overshooting of the overshooting cell from the cell group may include: determining the first cell most affected by the overshooting of the overshooting cell among the other cells according to handover information of the overshooting cell and the other cells in the cell group.

The determining of the adjustment step corresponding to the overshooting cell according to the cell relationship intimacy degree and the overlap coverage ratio between the overshooting cell and the first cell may include: determining a coverage shrinkage factor corresponding to the overshooting cell according to the cell relationship intimacy degree and the overlap coverage ratio between the overshooting cell and the first cell; and determining the adjustment step corresponding to the overshooting cell according to the coverage shrinkage factor.

The method may further comprise: determining the adjustment steps corresponding to other cells except for the overshooting cell in the cell group; and adjusting the coverage ranges of the other cells based on the determined adjustment steps corresponding to the other cells.

The determining of the adjustment steps corresponding to the other cells except for the overshooting cell in the cell group may include: determining the adjustment step corresponding to a first cell most affected by overshooting of the overshooting cell in the cell group to a specified value; and determining, according to relationship intimacy degree and/or overlap coverage ratios between a second cell among the other cells and cells in the cell group other than the second cell, the adjustment step corresponding to the second cell, wherein the second cell is a cell in the cell group other than the overshooting cell and the first cell.

The determining of the adjustment steps corresponding to the other cells except for the overshooting cell in the cell group may include: based on the other cell belonging to a plurality of cell groups comprising the cell group at the same time: based on the other cell being a first cell in at least one cell group of the plurality of cell groups, determining the adjustment step of the other cell as a specified value, wherein the first cell is a cell most affected by overshooting of the overshooting cell in the at least one cell group; based on the other cell not being the first cell in any of the plurality of cell groups, determining the adjustment step corresponding to the other cell according to a credibility profile of each cell group among the plurality of cell groups.

The credibility profile of each cell group may be determined based on relevant network parameters of each cell group.

The relevant network parameters of each cell group may include at least one of an average cell relationship intimacy degree between all cells in each cell group, a total number of served users in each cell group, a total number of cells in each cell group, an average system throughput of each cell group, and an average edge user throughput of each cell group.

The determining of the adjustment step corresponding to the other cell according to the credibility profile of each cell group among the plurality of cell groups may include: acquiring the adjustment step corresponding to the other cell determined based on each cell group respectively; determining a credibility of each cell group based on the credibility profile of each cell group; and determining the adjustment step determined based on the cell group with the largest credibility as a final adjustment step corresponding to the other cell.

The determining of the credibility of each cell group based on the credibility profile of each cell group may include: calculating an area in a closed loop of the credibility profile of each cell group; and determining the credibility of each cell group according to the calculated area.

According to an example embodiment of the present disclosure, a method performed by a network node is provided, comprising: acquiring real-time transmission environment information of a cell; and determining whether the cell is an overshooting cell based on the real-time transmission environment information of the cell.

The acquiring of the real-time transmission environment information of the cell may include: acquiring cell-related data and/or user-related data; and acquiring the real-time transmission environment information of the cell based on the cell-related data and/or the user-related data.

The acquiring of the real-time transmission environment information of the cell based on the cell-related data and/or the user-related data may include: acquiring a current user location distribution and a current timing advance (TA) distribution of the cell based on the cell-related data and/or the user-related data; and acquiring the real-time transmission environment information of the cell according to the current user location distribution and the current TA distribution.

The cell-related data may include at least one of cell configuration information and cell historical TA data; and/or the user-related data may include measurement information reported by a served user in the cell.

The acquiring of the current user location distribution and the current timing advance (TA) distribution based on the cell-related data and the user-related data may include: predicting, using a first artificial intelligence network, a historical user location distribution of the cell based on the user-related data and the cell configuration information; predicting, using a second artificial intelligence network, the current user location distribution based on the historical user location distribution; and predicting, using a third artificial intelligence network, the current TA distribution based on the cell historical TA data.

The real-time transmission environment information represents a ratio of line-of-sight (LOS) transmissions and non-line-of-sight (NLOS) transmissions in the cell.

The determining of whether the cell is the overshooting cell based on the real-time transmission environment information of the cell may include: obtaining an actual coverage range of the cell based on a current user location distribution of the cell; obtaining a planned coverage range of the cell based on the real-time transmission environment information; and determining whether the cell is the overshooting cell according to the actual coverage range of the cell and the planned coverage range of the cell.

The obtaining of the planned coverage range of the cell based on the real-time transmission environmental information may include: determining a theoretical coverage range of the cell based on cell related data; and predicting, using a fourth artificial intelligence network, the planned coverage range based on the real-time transmission environmental information and the theoretical coverage range of the cell.

According to an example embodiment of the present disclosure, a method performed by a network node is provided, comprising: constructing a cell group, wherein the cell group comprises an overshooting cell and other cells related to the overshooting cell; and adjusting respective coverage ranges of the overshooting cell and the other cells.

The constructing of the cell group may include: constructing the cell group according to related information between cells, wherein the related information between the cells comprises at least one of neighbor cell information, handover information, interference information.

The constructing of the cell group according to the related information between the cells may include: determining relationship intimacy degree between a plurality of cells comprising the overshooting cell according to the related information between the cells, wherein the relationship intimacy degree represents an influence degree between the cells; constructing the cell group based on the acquired relationship intimacy degree.

The determining of the relationship intimacy degree between the plurality of cells comprising the overshooting cell according to the related information between the cells may include: determining, using a fifth artificial intelligence network, the relationship intimacy degree between the plurality of cells comprising the overshooting cell according to the related information between the cells.

The constructing of the cell group based on the acquired relationship intimacy degree may include: determining an overshooting level of each cell according to an actual coverage range and a planned coverage range of each cell among the plurality of cells; and constructing the cell group based on the determined overshooting level and the acquired relationship intimacy degree.

The determining of the overshooting level of each cell according to the actual coverage range and the planned coverage range of each cell among the plurality of cells may include: predicting, using a sixth artificial intelligence network, the overshooting level of each cell according to the actual coverage range and the planned coverage range of each cell.

The constructing of the cell group based on the determined overshooting level and the acquired relationship intimacy degree may include: performing a following operation for each overshooting cell in turn according to the overshooting level; and selecting at least one cell from the other cells to form the cell group with the overshooting cell based on the relationship intimacy degree between the overshooting cell and the other cells.

The method may further comprise: determining the adjustment step corresponding to the overshooting cell, and determining the adjustment steps corresponding to the other cells, wherein the adjusting of the respective coverage ranges of the overshooting cell and the other cells may include: adjusting the coverage range of the overshooting cell based on the adjustment step corresponding to the overshooting cell, and adjusting the coverage ranges of the other cells based on the adjustment steps corresponding to the other cells.

The determining of the adjustment step corresponding to the overshooting cell may include: determining the adjustment step corresponding to the overshooting cell according to overshooting related information between the overshooting cell and other cells in the cell group.

The determining of the adjustment steps corresponding to the other cells may include: determining the adjustment step corresponding to a first cell most affected by overshooting of the overshooting cell in the cell group to a predetermined value; and determining, according to relationship intimacy degree and/or overlap coverage ratios between a second cell among the other cells and cells in the cell group other than the second cell, the adjustment step corresponding to the second cell, wherein the second cell is a cell in the cell group other than the overshooting cell and the first cell.

The determining of the adjustment steps corresponding to the other cells may include: based on the other cell belonging to a plurality of cell groups comprising the cell group at the same time: based on the other cell being a first cell in at least one cell group of the plurality of cell groups, determining the adjustment step of the other cell as a specified value, wherein the first cell is a cell most affected by overshooting of the overshooting cell in the at least one cell group; based on the other cell not being the first cell in any of the plurality of cell groups, determining the adjustment step corresponding to the other cell according to a credibility profile of each cell group among the plurality of cell groups.

The credibility profile of each cell group may be determined based on relevant network parameters of each cell group.

The relevant network parameters of each cell group may include at least one of an average cell relationship intimacy degree between all cells in each cell group, a total number of served users in each cell group, a total number of cells in each cell group, an average system throughput of each cell group, an average edge user throughput of each cell group.

The determining of the adjustment step corresponding to the other cell according to the credibility profile of each cell group among the plurality of cell groups may include: acquiring the adjustment step corresponding to the other cell determined based on each cell group respectively; determining a credibility of each cell group based on the credibility profile of each cell group; and determining the adjustment step determined based on the cell group with the largest credibility as a final adjustment step corresponding to the other cell.

The determining of the credibility of each cell group based on the credibility profile of each cell group may include: calculating area in a closed loop of the credibility profile of each cell group; and determining the credibility of each cell group according to the calculated area.

According to an example embodiment of the present disclosure, a network node is provided, comprising: a transceiver; at least one processor, comprising processing circuitry, coupled to the transceiver and individually and/or collectively configured to perform the method performed by the network node as described above.

According to an example embodiment of the present disclosure, a non-transitory computer-readable storage medium storing instructions is provided, the instructions, when executed by at least one processor, individually and/or collectively, cause a network node to perform the method performed by the network node as described above.

According to various example embodiments of the present disclosure, since the network node, after detecting the overshooting cell, determines the adjustment step corresponding to the overshooting cell based on the coverage situation of the overshooting cell, and then, adjusts the coverage range of the overshooting cell based on the determined adjustment step, compared with adjusting the coverage range using a pre-set and always-fixed adjustment step for all cells, it is able to better satisfy differentiated needs of different scenarios.

According to various example, embodiments of the present disclosure, since it is determined whether the cell is the overshooting cell based on the real-time transmission environment information of the cell, the accuracy of the detection of the overshooting cell may be effectively improved.

According to various example embodiments of the present disclosure, since after constructing the cell group including the overshooting cell and other cells related to the overshooting cell, in addition to adjusting the coverage range of the overshooting cell, the coverage ranges of the other cells are adjusted, it not only addresses the problem of overshooting of the overshooting cell, but also facilitates avoiding the occurrence of a coverage hole between the overshooting cell and other cells at the same time, thereby preventing and/or reducing the occurrence of call drops for users, improving the overall stability of the network, and facilitating the realization of the global optimization of the overall network.

It should be understood that the above general description and the detailed descriptions that follow are merely illustrative examples and do not limit the present disclosure.

### BRIEF DESCRIPTION OF THE DRAWINGS

The accompanying drawings herein are incorporated into and form part of the disclosure, illustrate various example embodiments consistent with the disclosure, which are used in conjunction with the disclosure to explain the principles of the disclosure and do not limit of the disclosure. Further, the above and other aspects, features and advantages of certain embodiments of the present disclosure will be more apparent from the following detailed description, taken in conjunction with the accompanying drawings, in which:

FIGS. 1A and 1B are diagrams illustrating and example of overshooting;

FIGS. 2A and 2B are diagrams illustrating a problem existing in adjusting a coverage range by adopting a fixed adjustment step.

FIGS. 3A and 3B are diagrams illustrating a problem existing in detecting an overshooting cell by adopting fixed transmission environment.

FIG. 4 is a diagram illustrating a problem existing in adopting a distributed adjustment scheme for overshooting management.

FIG. 5 is a flowchart illustrating an example method performed by a network node according to various embodiments;

FIG. 6 is a diagram illustrating acquisition of multimodal data according to various embodiments;

FIG. 7 is a diagram illustrating an example of detecting an overshooting cell and determining an overshooting level using an artificial intelligence network according to various embodiments;

FIG. 8 is a diagram illustrating a user location distribution of a cell according to various embodiments;

FIG. 9 is a diagram illustrating example construction of an adjacency relationship table according to various embodiments;

FIG. 10 is a diagram illustrating an example of a feature relationship table according to various embodiments;

FIG. 11 is a diagram illustrating example construction of a cell relationship intimacy degree table according to various embodiments;

FIG. 12 is a diagram illustrating an example of constructing a cell group according to various embodiments;

FIG. 13 is a diagram illustrating an example of calculating RSRP differences between cells according to various embodiments;

FIG. 14 is a table illustrating an example of overlap coverage ratios between cells according to various embodiments;

FIG. 15 is a table illustrating an example of the number of handover failures between cells according to various embodiments;

FIG. 16 is a diagram illustrating an example of a mapping table between a coverage shrinkage factor and an adjustment step according to various embodiments;

FIG. 17 is a diagram illustrating an example of a cell belonging to two cell groups at the same time according to various embodiments;

FIG. 18 is a diagram illustrating an example of determining a credibility profile of a cell group according to various embodiments;

FIG. 19 is a signal flow diagram illustrating an example method performed by a network node according to various embodiments;

FIG. 20 is a diagram illustrating an example illustrating a deployment scenario according to various embodiments;

FIG. 21 is a flowchart illustrating an example method performed by a network node according to various embodiments;

FIG. 22 is a flowchart illustrating an example method performed by a network node according to various embodiments;

FIG. 23 is a block diagram illustrating an example configuration of a network node according to various embodiments; and

FIG. 24 is a block diagram illustrating an example configuration of an electronic apparatus according to various embodiments.

The same reference numerals are used to represent the same elements throughout the drawings.

### DETAILED DESCRIPTION

The description is provided below with reference to the accompanying drawings to facilitate understanding of various embodiments of the present disclosure. This description includes various specific details to help with understanding but should only be considered to be illustrative. Those skilled in the art will realize that various embodiments described here can be varied and modified without departing from the scope and spirit of the present disclosure. In addition, the description of function and structure of the common knowledge may be omitted for clarity and conciseness.

The terms and expressions used in the claims and the description below are not limited to their lexicographical meaning but are used to enable the clear and consistent understanding of the present disclosure. Therefore, it should be apparent to those skilled in the art that the following description of the various embodiments of the present disclosure is provided only for the purpose of the illustration without limiting the present disclosure.

It will be understood that, unless specifically stated, the singular forms “one”, “a”, and “said” used herein may also include the plural form. Thus, for example, “component surface” refers to one or more such the surfaces. When we state that one element is “connected” or “coupled” to another element, the one element may be directly connected or coupled to the another element, or a connection relationship between the one element and the another element may be established through an intermediate element. In addition, “connect” or “couple” used herein may include a wireless connection or wireless coupling.

The terms “includes” and “may include” refer, for example, to the presentation of the corresponding disclosed functions, operations, or components that can be used in various embodiments of the present disclosure, but do not limit the presentation of one or more additional functions, operations, or features. In addition, it should be understood that the terms “including” or “having” may be interpreted to refer, for example, to certain features, numbers, steps, operations, components, assemblies or combinations thereof, but should not be interpreted to exclude the possibility of the existence of one or more of other features, numbers, steps, operations, components, assemblies and/or combinations thereof.

The term “or” used in various embodiments of the disclosure herein includes any listed term and all combinations thereof. For example, “A or B” may include A, or include B, or include both A and B. When a plurality of (two or more) items are described, if a relationship between the plurality of items is not clearly defined, “between the plurality of items” may refer to one, some or all of the plurality of items. For example, for a description “a parameter A includes A1, A2, A3”, it may be implemented that the parameter A includes A1, or A2, or A3, and it may also be implemented that the parameter A includes at least two of the three parameters A1, A2, A3.

Unless defined differently, all terms as used in the present disclosure (including technical or scientific terms) have the same meanings as understood by those skilled in the art as described in the present disclosure. As common terms defined in dictionaries are interpreted to have meanings consistent with those in the context in the relevant technical field, and they should not be idealized or overly formalized unless expressly defined as such in the present disclosure.

At least some of the functions in the device or electronic apparatus provided in the embodiments of the disclosure may be implemented through an AI model, for example, at least one module among a plurality of modules of the device or electronic apparatus may be implemented through the AI model. Functions associated with AI may be performed by a non-volatile memory, a volatile memory, and processors.

A processor may include one or more processors. The one or more processors may be a general-purpose processor, such as a central processing unit (CPU), an application processor (AP), etc., or a processor used only for graphics, such as, a graphics processing unit (GPU), a visual processing unit (VPU), and/or an AI dedicated processor (such as, a neural processing unit (NPU). The one or mor processors according to an embodiment of the disclosure may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

In various examples of the disclosure described below, a hardware approach will be described as an example. However, since various embodiments of the disclosure may include a technology that utilizes both the hardware-based and the software-based approaches, they are not intended to exclude the software-based approach.

As used herein, the terms referring to merging (e.g., merging, grouping, combination, aggregation, joint, integration, unifying), the terms referring to signals (e.g., packet, message, signal, information, signaling), the terms referring to resources (e.g. section, symbol, slot, subframe, radio frame, subcarrier, resource element (RE), resource block (RB), bandwidth part (BWP), opportunity), the terms used to refer to any operation state (e.g., step, operation, procedure), the terms referring to data (e.g. packet, message, user stream, information, bit, symbol, codeword), the terms referring to a channel, the terms referring to a network entity (e.g., distributed unit (DU), radio unit (RU), central unit (CU), control plane (CU-CP), user plane (CU-UP), O-DU-open radio access network (O-RAN) DU), O-RU (O-RAN RU), O-CU (O-RAN CU), O-CU-UP (O-RAN CU-CP), O-CU-CP (O-RAN CU-CP)), the terms referring to the components of an apparatus or device, or the like are only illustrated for convenience of description in the disclosure. Therefore, the disclosure is not limited to those terms described below, and other terms having the same or equivalent technical meaning may be used therefor. Further, as used herein, the terms, such as ‘˜ module’, ‘˜ unit’, ‘˜ part’, ‘˜ body’, or the like may refer to at least one shape of structure or a unit for processing a certain function.

Further, throughout the disclosure, an expression, such as e.g., ‘above’ or ‘below’ may be used to determine whether a specific condition is satisfied or fulfilled, but it is merely of a description for expressing an example and is not intended to exclude the meaning of ‘more than or equal to’ or ‘less than or equal to’. A condition described as ‘more than or equal to’ may be replaced with an expression, such as ‘above’, a condition described as ‘less than or equal to’ may be replaced with an expression, such as ‘below’, and a condition described as ‘more than or equal to and below’ may be replaced with ‘above and less than or equal to’, respectively. Furthermore, hereinafter, ‘A’ to ‘B’ means at least one of the elements from A (including A) to B (including B). Hereinafter, ‘C’ and/or ‘D’ means including at least one of ‘C’ or ‘D’, that is, {′C′, ‘D’, or ‘C’ and ‘D’}.

The disclosure describes various embodiments using terms used in some communication standards (e.g., 3rd Generation Partnership Project (3GPP), extensible radio access network (xRAN), open-radio access network (O-RAN) or the like), but it is only of an example for explanation, and the various embodiments of the disclosure may be easily modified even in other communication systems and applied thereto.

The one or more processors may control the processing of input data according to predefined operation rules or AI models stored in a non-volatile memory and a volatile memory. The predefined operation rules or AI models may be provided through training or learning.

Providing by learning may refer, for example, to the predefined operation rules or AI models with desired characteristics being obtained by applying a learning algorithm to a plurality of learning data. The learning may be performed in the device or the electronic apparatus itself executing AI according to the embodiment, and/or may be implemented by a separate server/system.

The AI models may include a plurality of neural network layers. Each layer includes a plurality of weight values, and performs a neural network calculation by performing a calculation between the input data of this layer (for example, the calculation results of the previous layer and/or the input data of the AI model) and the plurality of weight values of the current layer. Examples of the neural network include, but are not limited to, a convolution neural network (CNN), a depth neural network (DNN), a recurrent neural network (RNN), a restricted Boltzmann machine (RBM), a depth confidence network (DBN), a bidirectional recursive depth neural network (BRDNN), a generative countermeasure network (GAN), a depth Q network, etc.

A learning algorithm may refer to a method that uses a plurality of learning data to train a predetermined target apparatus (for example, a robot) to enable, allow, or control the target apparatus to make a determination or prediction. Examples of the learning algorithm include, but are not limited to, supervised learning, unsupervised learning, semi supervised learning, or reinforcement learning.

According to the present disclosure, at least one step of a method performed by a network node or user equipment, such as the step of detecting an overshooting cell, determining a specific adjustment step for the overshooting cell, may be implemented using an artificial intelligence model. The processor of the electronic apparatus may perform preprocessing operations on data to convert it into a form suitable for use as input to artificial intelligence models. The artificial intelligence models may be obtained through training. Here, “obtained through training” may refer, for example, to training a basic artificial intelligence model with a plurality of training data through a training algorithm to obtain the predefined operation rules or artificial intelligence models, which are configured to perform the required features (or purposes).

Below, the various example embodiments of the disclosure and the technical effects produced by the disclosure will be explained by describing various example embodiments. It should be pointed out that the following implementations can be mutually referenced, drawn, or combined, and for the same terms, similar features, and similar implementation steps in different implementations, they may not be repeated.

The overshooting phenomenon has become a common phenomenon in wireless communication networks, for example, the phenomenon is prevalent in B5G/5G networks. The overshooting phenomenon is a long-standing phenomenon in B5G/5G networks due to changes in the building environment and topology caused by the increase in the number of mobile stations, femtocells, and changes in antenna configurations caused by new functions. Overshooting management is a major challenge to improve communication performance, which has attracted global attention and deserves to be investigated. For user equipment, call drops or call blocking due to severe overshooting are unacceptable and should be eliminated/reduced, and data rates need to be improved by solving the overshooting problem to obtain a better service experience.

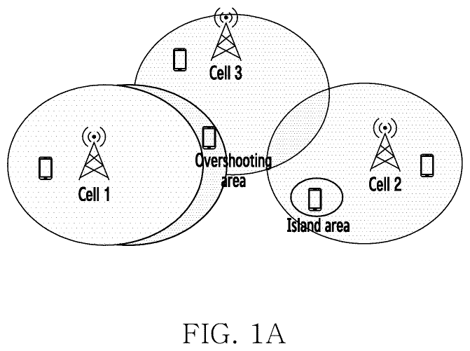

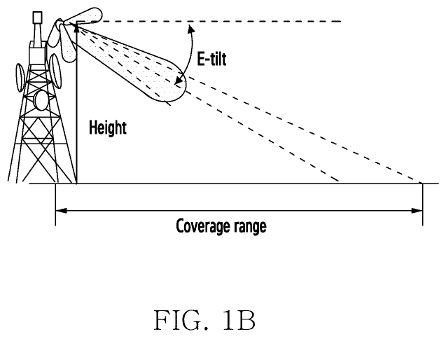

The overshooting phenomenon generally refers to the coverage range of a cell exceeding the planned coverage range, which forms an overshooting area or an island area in other cells and results in call drops, call blocking and reduced throughput of the user equipment (UE). An island area also belongs to a type of overshooting area, which is a special type of overshooting area that may be formed in neighbor cells or in cells other than neighbor cells. FIGS. 1A and 1B are diagrams illustrating overshooting. For example, as shown in FIG. 1A, the coverage range of cell 1 exceeds its planned coverage range, which forms not only a general overshooting area in its neighbor cell 3, but also an island area in cell 2 other than its neighbor cells. As shown in FIG. 1B, the overshooting is usually caused by an inappropriate electronic down-tilt angle (e-tilt) of the base station, inappropriate antenna height of the base station, and so on, therefore, the coverage range of the overshooting cell may be adjusted, for example, by adjusting the e-tilt of the antenna of the base station, the antenna height, and so on.

When addressing the overshooting problem, it is usually divided into two steps: first, the base station detects whether the current cell is an overshooting cell based on a fixed transmission environment; second, if the cell is an overshooting cell, the e-tilt of the antenna is adjusted downward based on a fixed step to adjust the coverage range thereof, and various embodiments adopt a distributed overshooting management scheme, that is, adjusting its coverage range only for the overshooting cell without considering the other cells. Wherein the fixed transmission environment may refer, for example, to the same and fixed planned coverage being used for all cells without considering the transmission environment of the cells, and the same method is used to calculate the actual coverage. The planned coverage is the configured value, and the actual coverage is calculated according to the TA (timing advance) distribution. TA is the time of signal transmission calculated by the base station according to the random access code transmitted by the user, and according to the TA value transmitted by the base station to each user, the distance of the signal transmitting from the base station to the user may be calculated, and if this distance is outside of the planned coverage of the cell, the cell is an overshooting cell. The fixed step may refer, for example to the adjustment step being fixed for all cells and not changing over time.

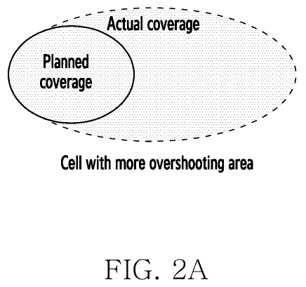

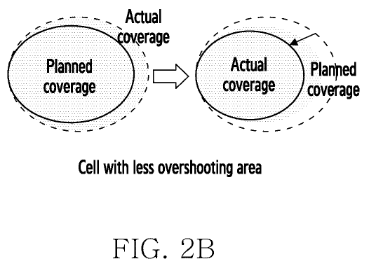

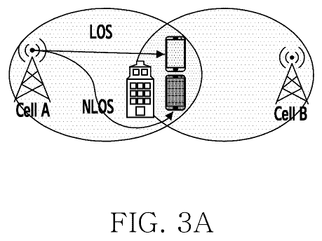

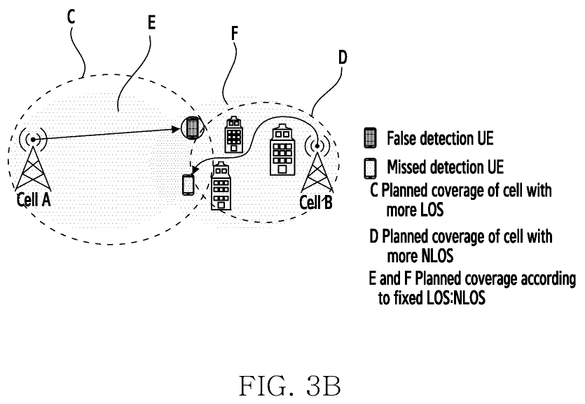

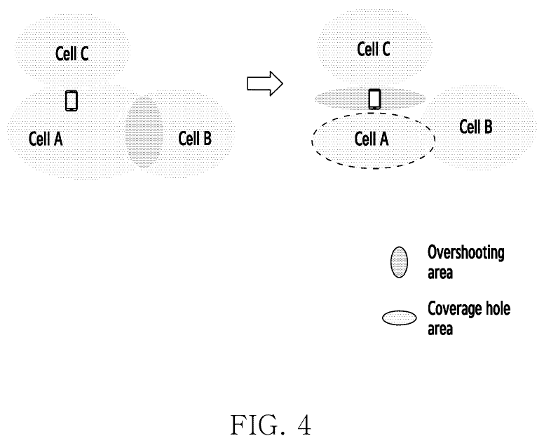

However, the above manner of addressing the overshooting problem has at least the following three problems:
Problem 1: the adjustment scheme based on the fixed step leads to the inability to satisfy the differentiated requirements of different scenarios, which results in long adjustment time or call drops.
   For cells with severe overshooting, a large step adjustment is required, and using the fixed step will lead to a slow adjustment and slow performance improvement. For example, as shown in FIG. 2A, if the fixed adjustment step is small, more adjustments are required for the cell with more overshooting areas, and if the adjustment period is at least 1 day, longer adjustment time is required to address the overshooting problem.
   For cells with slight overshooting, a small step adjustment is required, and if the fixed step is used, it will lead to an over adjustment and missing of the optimal setting. For example, as shown in FIG. 2B, if the fixed adjustment step is large, a smaller adjustment is required for cell with less overshooting areas, and the actual coverage range becomes too small after the large step adjustment, and thus, the coverage hole may occur and call drops occur.
Problem 2: missed detection and false detection exist in the detection scheme for the overshooting cell based on the fixed transmission environment, which results in low detection accuracy. The reasons for this are firstly because each cell has different transmission environment and should use different planned coverage, and secondly because TA is not equivalent to the straight line distance, and in NLOS (non-line of sight) environment, a signal will be refracted many times, and the calculated distance is not the straight line distance, which does not represent the distance from the user to the base station. For example, the actual coverage is calculated based on the TA distribution in the LOS (line of sight) environment, however, as shown in FIG. 3A, for the NLOS environment, a large TA will make the actual coverage too large, which leads to false detection. In addition, as shown in FIG. 3B, for cells with more LOS, a signal is transmitted over a longer distance, and thus the planned coverage should be larger, while for cells with more NLOS, the planned coverage should be smaller, however, if the planned coverage is always calculated based on the fixed transmission environment (e.g., LOS:NLOS=2:8), it may lead to missed detection and false detection. The false detection may lead to an increase in call drop rate and call blocking rate and a decrease in system throughput. The missed detection, on the other hand, may lead to the overshooting problem unresolved, cell throughput not being improved, and call drops continuing to occur.
Problem 3: the overshooting management scheme based on distribution, which only considers the performance of this cell, may lead to the coverage hole in the network after the adjustment and frequent call drops for users, which destroys the stability of the network and fails to achieve the global optimization of the overall network. For example, as shown in FIG. 4, if cell A is an overshooting cell, the overshooting problem of cell A is addressed after adjusting the e-tilt of the antenna of cell A. However, a coverage hole area occurs between cell A and cell C, and UEs in this region experience call drops (handover failures) or call blocking (inability to initiate a call).

As to the above problems, the present disclosure provides a method performed by a network node, the method according to the present disclosure may better realize overshooting management.

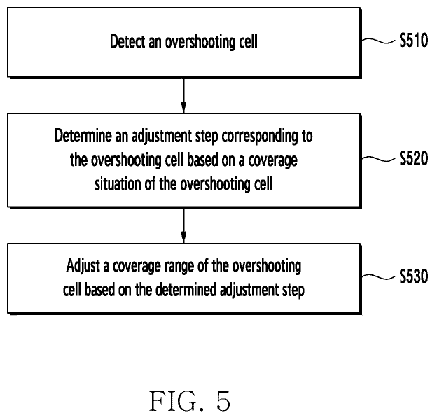

FIG. 5 is a flowchart illustrating an example method performed by a network node according to various embodiments.

Referring to FIG. 5, in step S510, an overshooting cell is detected. In step S520, an adjustment step corresponding to the overshooting cell is determined based on a coverage situation of the overshooting cell. In step S530, the coverage range of the overshooting cell is adjusted based on the determined adjustment step.

According to the method shown in FIG. 5, since the network node, after detecting the overshooting cell, determines the adjustment step corresponding to the overshooting cell based on the coverage situation of the overshooting cell, and then, adjusts the coverage range of the overshooting cell based on the determined adjustment step, compared with adjusting the coverage range using a pre-set and always-fixed adjustment step for all cells, it is able to better satisfy differentiated needs of different scenarios, and thus the above problem 1 may be effectively addressed.

According to various embodiments, the network node referred to in the present disclosure may be a control node on the network side, for example, a SON (self-organized network) manager, an ORAN (open radio access network) entity, an RIC (RAN intelligent controller) entity, but is not limited thereto. In addition, the different functions involved in the above method of the present disclosure may be accomplished by a plurality of sub-entities respectively, and the connection between the sub-entities may be a wired connection or a wireless connection.

Hereinafter, the steps in the method shown in FIG. 5 are described in greater detail taking the example of the network node being a SON manager.

According to various embodiments, step S510 may include: acquiring real-time transmission environment information of a cell; determining whether the cell is the overshooting cell based on the real-time transmission environment information of the cell.

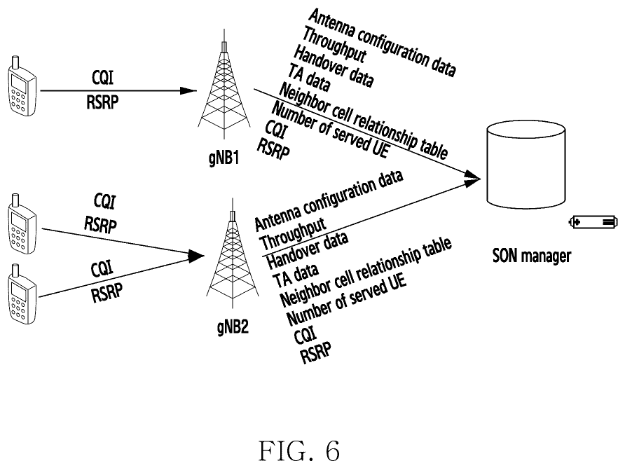

According to the above-described manner of detecting an overshooting cell of the present disclosure, since the real-time transmission environment information of the cell is first acquired and then whether the cell is the overshooting cell is determined based on the real-time transmission environment information of the cell, compared to detecting the overshooting cell always based on fixed transmission environment, the missed detection and false detection may be better avoided, and the accuracy of the overshooting detection is improved, and thus the above problem 2 may be effectively addressed. According to various embodiments, the acquiring of the real-time transmission environment information of the cell may include: acquiring cell-related data and/or user-related data; acquiring the real-time transmission environment information of the cell based on the cell-related data and/or the user-related data. For example, as shown in FIG. 6, the SON manager may acquire the cell-related data from a base station (gNB) and acquire the user-related data measured and reported from a UE. According to various embodiments, the cell-related data may include at least one of cell configuration information and cell historical TA data. The cell-related data may further include cell performance data. For example, the cell configuration information may include antenna configuration data and a neighbor cell relationship table of the cell, but is not limited thereto. For example, the antenna configuration data may include at least one of antenna height, an antenna azimuth, an antenna mechanical down-tilt angle (m-tilt), an antenna e-tilt, antenna transmitting power, and an antenna location, but is not limited thereto. For example, cell historical TA data may include the count of TA values under each TA index, but is not limited thereto. For example, cell performance information may include the number of users served by the cell, throughput of the cell, handover data of the cell, and the like. For example, user-related data measured and reported by the UE may include at least one of a channel quality indicator (CQI) and reference signal receiving power (RSRP), but is not limited thereto.

According to various embodiments, the acquiring of the real-time transmission environmental information of the cell based on the cell-related data and/or the user-related data may include: acquiring a current user location distribution and a current timing advance (TA) distribution of the cell based on the cell-related data and/or the user-related data; acquiring the real-time transmission environment information of the cell according to the current user location distribution and the current TA distribution.

According to various embodiments, the acquiring of the current user location distribution and the current timing advance (TA) distribution based on the cell-related data and the user-related data may include: predicting, using a first artificial intelligence (AI) network, a historical user location distribution of the cell based on the user-related data and the cell configuration information, and predicting, using a second artificial intelligence network, the current user location distribution based on the historical user location distribution; and predicting, using a third artificial intelligence network, the current TA distribution based on the cell historical TA data. For example, the cell configuration information may include a base station location, a m-tilt, an e-tilt, transmit power, and height of a cell antenna, but is not limited thereto. For example, the cell historical TA data may include counts of TA values under a plurality of TA indexes.

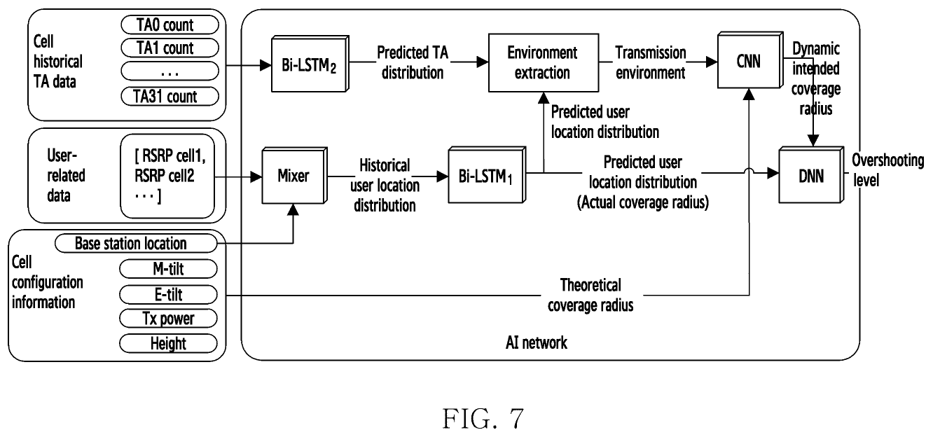

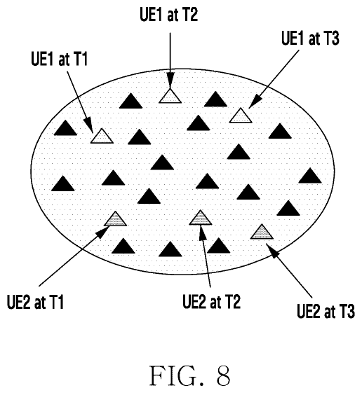

For example, as shown in FIG. 7, the historical user location distribution of each cell may be predicted utilizing the Mixer network, based on user-related data (e.g., historical RSRPs with different cells measured and reported by UE) and cell configuration information (e.g., including a base station location, a m-tilt, an e-tilt, a transmit power, and height of a cell antenna). The historical user location distribution represents the historical locations of all UEs within a cell at different historical moments, as shown in FIG. 8. As an example, a 7-layer Mixer network may be selected because of its low complexity and the strong data fitting ability, but the selection of the number of layers of the Mixer network is not limited to 7 layers, instead it may be set to other number of layers according to the actual need, and the present disclosure does not limit this. It should be noted that although the first artificial intelligence network is shown as the Mixer network in the example of FIG. 7, however, the first artificial intelligence network is not limited to the Mixer network, but may be any type of artificial intelligence network, and the present disclosure does not limit this.

As shown in FIG. 7, after predicting the historical user location distribution of the cell, the current user location distribution may be predicted utilizing a bidirectional long short-term memory network (Bi-LSTM) (labeled as “Bi-LSTM₁” in FIG. 7), based on the historical user location distribution. For example, a 4-layer Bi-LSTM network may be selected because of its high prediction accuracy, but the selection of the number of layers of the Bi-LSTM network is not limited to 4 layers, instead it may be set to other number of layers according to the actual need, and the present disclosure does not limit this. It should be noted that although the second artificial intelligence network is shown as the Bi-LSTM network in the example of FIG. 7, however, the second artificial intelligence network is not limited to the Bi-LSTM network, but may be any type of artificial intelligence network, and the present disclosure does not limit this. An actual coverage range of the cell (e.g., an actual coverage radius of the cell) may be obtained based on the predicted user location distribution. In the above example of the present disclosure, obtaining the actual coverage range of the cell based on the predicted user location distribution compared to calculate the actual coverage range based on the TA distribution, the obtained actual coverage range is more accurate.

As shown in FIG. 7, the current TA distribution of the cell may be predicted utilizing the Bi-LSTM network (labeled as “Bi-LSTM₂” in FIG. 7), based on the historical TA data of the cell (such as including the count of TA0, the count of TA1 . . . the count of TA31). It is noted that although the third artificial intelligence network is shown as the Bi-LSTM network in the example of FIG. 7, however, the third artificial intelligence network is not limited to the Bi-LSTM network, but may be any type of artificial intelligence network, and the present disclosure does not limit this.

After predicting the current user location distribution and the current TA distribution using the artificial intelligence network, the real-time environmental information of the cell may be acquired according to the predicted current user location distribution and the current TA distribution. According to various embodiments, the real-time transmission environment may represent a ratio of LOS transmissions and NLOS transmissions in the cell. The more the LOSs are, the larger the planned coverage range is. The ratio of LOS and NLOS of each cell may be calculated by the TA distribution and the user location distribution. For each user, if the distance from the user to the base station calculated according to the TA distribution is the same as the distance from the user to the base station calculated according to the user location distribution, the user is in LOS environment in this cell; otherwise, the user is in NLOS environment in this cell. By counting the transmission environment of all users, the ratio of LOS and NLOS in the cell may be obtained, and then the real-time transmission environment information of the cell may be acquired.

After acquiring the real-time transmission environment information of the cell, it may be determined whether the cell is the overshooting cell based on the real-time transmission environment information of the cell.

According to various embodiments, the determining of whether the cell is the overshooting cell based on the real-time transmission environment information of the cell may include: obtaining an actual coverage range of the cell based on a current user location distribution of the cell; and obtaining a planned coverage range of the cell based on the real-time transmission environment information; determining whether the cell is the overshooting cell according to the actual coverage range of the cell and the planned coverage range of the cell.

As an example, the obtaining of the planned coverage range of the cell based on the real-time transmission environmental information may include: determining a theoretical coverage range of the cell based on cell related data; predicting, using a fourth artificial intelligence network, the planned coverage range based on the real-time transmission environmental information and the theoretical coverage range of the cell. For example, as shown in FIG. 7, the theoretical coverage range may be determined based on a base station location, a m-tilt, an e-tilt, transmit power, and height of a cell antenna, and thereafter, the planned coverage range may be predicted utilizing a convolutional neural network (CNN), based on the real-time transmission environment information and the theoretical coverage range of the cell. The planned coverage range may also be referred to as “intended coverage range”, e.g., the intended coverage range may be indicated by an intended coverage radius. For example, antenna configuration data in cell modal data may indicate an upper boundary of the cell coverage range and may be used as a reference for determining the dynamic planned coverage. In the example of FIG. 7, the fourth artificial intelligence model may be a CNN, and the CNN network is selected because of its high feature extraction capability, for example, a 5-layer CNN network may be selected. However, the fourth AI network is not limited to the CNN, but may be any type of AI network, and the number of layers of the AI network is not limited to 5 layers.

After obtaining the actual coverage range of the cell and the planned coverage range of the cell, it may be determined whether the cell is the overshooting cell according to the actual coverage range of the cell and the planned coverage range of the cell. As mentioned above, the actual coverage range of the cell may be obtained based on the predicted current user location distribution of the cell. For example, the actual coverage radius of the cell may be obtained based on the predicted current user location distribution of the cell, and whether the cell is the overshooting cell is determined by comparing the actual coverage radius of the cell with the predicted planned coverage radius. For example, if the actual coverage radius of the cell exceeds the planned coverage radius, it is determined that the cell is the overshooting cell, and otherwise, it is not the overshooting cell.

According to various embodiments of the present disclosure, since the planned coverage range of the cell is obtained based on the real-time transmission environment of the cell, the obtained planned coverage range of the cell is dynamic, and since the actual coverage range of the cell is obtained based on the current user location distribution, the obtained actual coverage range is more accurate, further, since it is determined whether the cell is the overshooting cell according to the more accurate actual coverage range and the dynamic planned coverage range, the overshooting cell may be more accurately detected.

Referring back to FIG. 5, after detecting the overshooting cell, in step S520, an adjustment step corresponding to the overshooting cell may be determined based on a coverage situation of the overshooting cell.

According to various embodiments, step S520 may include: determining the adjustment step corresponding to the overshooting cell according to an actual coverage range and a planned coverage range of the overshooting cell. For example, the actual coverage range of the overshooting cell may be obtained based on the current user location distribution of the overshooting cell, and the planned coverage range of the overshooting cell may be obtained based on the real-time transmission environment of the overshooting cell. Since the adjustment step specific to the overshooting cell is determined based on the more accurate real-time coverage range and the dynamic planned coverage range, the adjustment step specific to the overshooting cell may be determined dynamically and more accurately, which enables to satisfy the differentiated needs of different scenarios.

According to an embodiment, step S520 may include: constructing a cell group according to related information between cells, wherein the cell group includes the overshooting cell; determining the adjustment step corresponding to the overshooting cell according to overshooting related information between the overshooting cell and other cells in the cell group. As an example, the related information between the cells may include at least one of neighbor cell information, handover information, interference information. Since the adjustment step corresponding to the overshooting cell is determined according to the overshooting related information between the overshooting cell and other cells in the cell group, and the overshooting related information is dynamic, the adjustment step specific to the overshooting cell may be determined dynamically, which enables to satisfy the differentiated needs of different scenarios. In addition, determining the adjustment step corresponding to the overshooting cell according to the overshooting related information between the overshooting cell and other cells in the cell group by constructing the cell group is also more conducive to carrying out a union adjustment of the cell group, so as to avoid occurring a new coverage hole after addressing the overshooting problem.

According to various embodiments, the constructing of the cell group according to the related information between the cells may include: determining relationship intimacy degree between a plurality of cells including the overshooting cell according to the related information between the cells, wherein the relationship intimacy degree represents the influence magnitude of a change of one cell on another cell, and may represent an influence degree between the cells; and constructing the cell group based on the acquired relationship intimacy degree.

According to various embodiments, the relationship intimacy degree between cells may be obtained based on neighbor cell information, handover information, and interference information between cells. As a non-limiting example, an adjacency relationship table between the cells may be constructed firstly as the neighbor cell information according to the neighbor cell relationship table of each cell, secondly, a feature relationship table between the cells may be constructed according to the handover information and interference information between the cells, anda cell relationship intimacy degree table between the cells may be constructed according to the adjacency relationship table and the feature relationship table.

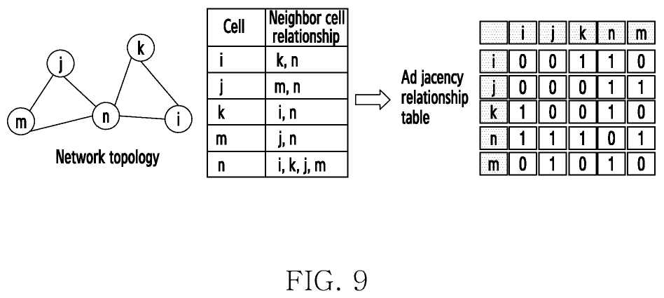

For example, if the network topology between the cells is as shown in FIG. 9, an adjacency relationship table as shown in FIG. 9 may be constructed based on the network topology, in the adjacency relationship table, 1 represents they are neighbor cells to each other, and 0 represents they are not neighbor cells to each other.

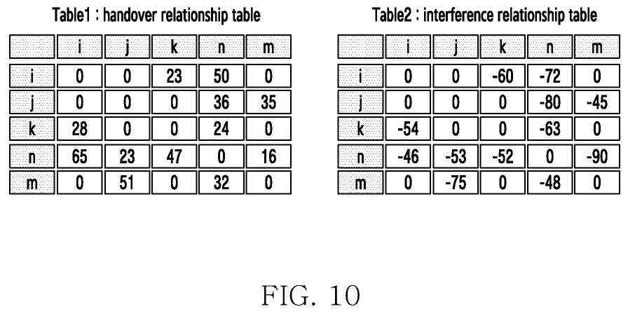

According to various embodiments, the feature relationship table between the cells may include a handover relationship table and an interference relationship table between the cells. For example, the handover relationship table may be shown in table 1 of FIG. 10 and the interference relationship table may be shown in table 2 of FIG. 10. The numbers shown in table 1 may be the number of handover attempts, the number of handover successes, or the number of handover failures between cells. The numbers shown in table 2 indicate the magnitude of the interference values between cells. It needs to be noted that the feature relationship between cells is not limited to include only the handover relationship and the interference relationship between cells, and the handover relationship table and interference relationship table are not limited to the example shown in FIG. 10.

According to various embodiments, the relationship intimacy degree between the plurality of cells including the overshooting cell may be determined using a fifth artificial intelligence network, according to the related information between the cells.

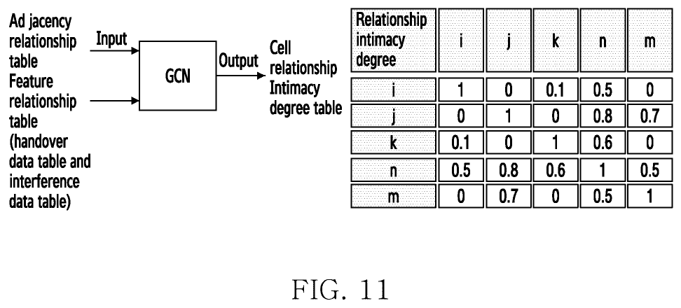

For example, after constructing the adjacency relationship table and the feature relationship table, as shown in FIG. 11, for example, a cell relationship intimacy degree table between the cells may be constructed according to the adjacency relationship table and the feature relationship table using a graph convolutional network (GCN). The larger the value of the cell relationship intimacy degree (CRID) is, the greater the coverage influence between cells on each other is. The greater the handover data is, the greater the cell relationship intimacy degree is; the greater the interference is, the greater the cell relationship intimacy degree is. If cell A is not in the neighbor cell relationship table of cell B, then the relationship intimacy degree between cell A and B is 0. It is to be noted that although the fifth AI network is shown as the GCN in the example of FIG. 11, the fifth AI network is not limited to the GCN, and may be any type of AI network.

After obtaining the relationship intimacy degree between the cells, the cell group may be constructed based on the obtained relationship intimacy degree. As an example, the relationship intimacy degree between the overshooting cell and other cells in the cell group satisfies a predetermined relationship intimacy degree requirement. For example, the relationship intimacy degree between the overshooting cell and the other cells in the cell group exceeds a predetermined threshold, e.g., 0.

According to various embodiments of the present disclosure, the constructing of the cell group based on the acquired relationship intimacy degree may include: determining an overshooting level of each cell according to an actual coverage range and a planned coverage range of each cell among the plurality of cells; and constructing the cell group based on the determined overshooting level and the acquired relationship intimacy degree. The manner of obtaining the actual coverage range and the planned coverage range of a cell has been described above, therefore, how to obtain the actual coverage range of each cell and the planned coverage range of the overshooting cell may not be repeated here, and relevant examples may be found in the description above.

As an example, the overshooting level of each cell may be determined using a sixth artificial intelligence network, according to the actual coverage range and the planned coverage range of each cell. Referring back to FIG. 7, for example, as shown in FIG. 7, the overshooting level of each cell may be predicted utilizing a deep neural network (DNN), according to the actual coverage range and the planned coverage range of each cell. For example, the overshooting level may be divided into a plurality of levels according to the size of the area of the overshooting area, with values ranging from 0 to 1. The larger the area of the overshooting area is, the higher the overshooting level is, and conversely, the smaller the area of the overshooting area is, the lower the overshooting level is. The size of the area of the overshooting area may be expressed by the number of overshooting users and the number of island users; the larger the number of overshooting users and the number of island users are, the larger the area of the overshooting is. When calculating the size of the area of the overshooting area, the number of island users may be weighted higher than the number of overshooting users. Both the number of overshooting users and the number of island users may be determined according to the predicted actual coverage range and the planned coverage range of the cell. In the example of FIG. 7, the DNN is selected to predict the overshooting level because it may obtain better results with lower complexity and lower input data dimensions, however, the sixth AI network used to predict the overshooting level is not limited to the DNN, but may be any other type of AI network, and the present disclosure does not limit this.

After the relationship intimacy degree between the plurality of cells has been acquired and the overshooting level has been determined, the cell group may be constructed based on the determined the overshooting level and the obtained relationship intimacy degree. According to various embodiments, a following operation for each overshooting cell may be performed in turn according to the overshooting level: selecting at least one cell from the other cells to form the cell group with the overshooting cell based on the relationship intimacy degree between the overshooting cell and the other cells. For example, the cell group may be constructed by the following steps: step 1, sorting the plurality of cells in descending order of the overshooting level; step 2, constructing the cell group for each the overshooting cell, the cell group is constructed starting from the first cell in the sorted queue. For example, the overshooting cell and all the cells whose relationship intimacy degree with the same is greater than 0 may be divided into one group; step 3, if an overshooting cell has already been divided into another cell group with a higher overshooting level, then this cell is skipped, and construction of the cell group for the next overshooting cell is started. Following the above steps, it may be realized that the cell group is constructed for each overshooting cell, wherein in the cell group, the relationship intimacy degree between the overshooting cell and the other cells in the cell group satisfies a predetermined relationship intimacy degree requirement, e.g., the relationship intimacy degree is greater than 0.

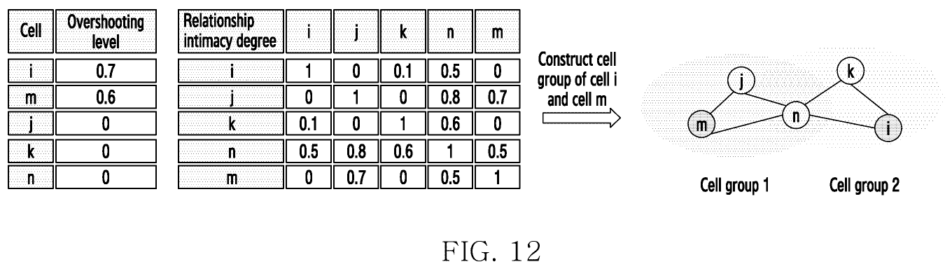

FIG. 12 is a diagram illustrating an example of constructing a cell group according to various embodiments. As shown in FIG. 12, after acquiring the relationship intimacy degree and the overshooting levels from cell i to cell n, the cell groups of overshooting cells i and m each may be constructed following steps 1 to 3 above, wherein the cell group of the overshooting cell i includes the overshooting cell i and the cells k and n whose relationship intimacy degree with the same is greater than 0, and the cell group of the overshooting cell m includes the overshooting cell m and the cells j and n whose relationship intimacy degree with the same is greater than 0.

After constructing the cell group, the adjustment step corresponding to the overshooting cell may be determined according to overshooting related information between the overshooting cell and other cells in the cell group.

According to various embodiments, the overshooting related information includes: relationship intimacy degree and/or an overlap coverage ratio. The method shown in FIG. 5 may further include: acquiring measurement information of the overshooting cell and at least one other cell in the cell group; and determining the overlap coverage ratio between the overshooting cell and the at least one other cell in the cell group according to the measurement information.

According to various embodiments, determining of the overlap coverage ratio between the overshooting cell and the at least one other cell in the cell group according to the measurement information may include: determining a measurement information difference value of a served user between the overshooting cell and the at least one other cell in the cell group according to the measurement information; determining a number of overlap areas between the overshooting cell and the at least one other cell in the cell group according to a comparison of the measurement information difference value with a set threshold; and determining the overlap coverage ratio between the overshooting cell and the at least one other cell in the cell group according to the number of the overlap areas between the overshooting cell and the at least one other cell in the cell group and a number of the measurement information. For example, wherein the measurement information includes the RSRP, but is not limited thereto.

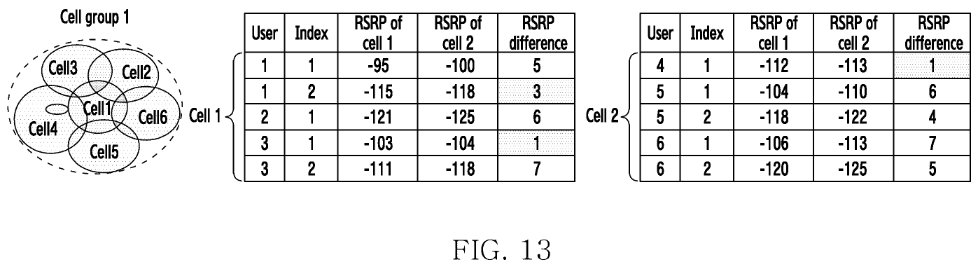

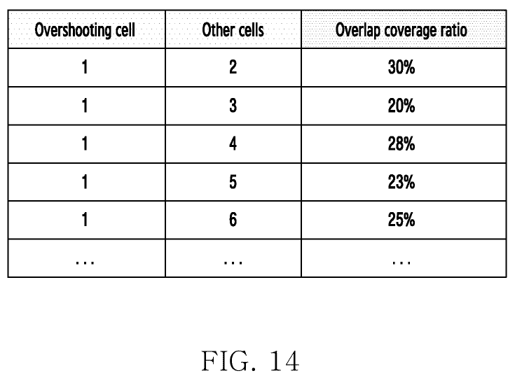

For example, the overlap coverage ratios between the overshooting cell and other cells may be determined by the following steps:
(I) collecting RSRP measurement results of served users in two cells in the cell group. For example, as shown in FIG. 13, RSRPs of served users in cell 1 (the overshooting cell) and cell 2 in cell group 1 may be collected. If there are two or more overshooting cells in one cell group, the cell with the highest overshooting level is selected as the only overshooting cell in the cell group.
(II) calculating RSRP difference values between two cells in the same cell group. For example, as shown in FIG. 13, the RSRP difference values of served users between cell 1 (the overshooting cell) and cell 2 may be calculated respectively for the served users between cell 1 (the overshooting cell) and cell 2. In the table of FIG. 13, the same user may correspond to one index or multiple indexes, e.g., the RSRP corresponding to each index may be the RSRP of the same user at different times.
(III) calculating the overlap coverage ratio according to the RSRP difference values. For example, if one RSRP difference value is less than or equal to 3 dB, then the number of the overlap areas is added by one.
(IV) calculating the overlap coverage ratios according to the overlap areas and the overall areas. The overall areas may be expressed with the total number of all RSRPs of all served users in two cells. For example, the overlap coverage ratios between the overshooting cell and the other cells of cell group 1 are shown in the table of FIG. 14.

Example manners of determining the relationship intimacy degree and the overlap coverage ratio have been described above, after determining the relationship intimacy degree and/or the overlap coverage ratio between the overshooting cell and at least one other cell in the cell group, the adjustment step corresponding to the overshooting cell may be determined according to the relationship intimacy degree and/or the overlap coverage ratio between the overshooting cell and the at least one other cell. According to various embodiments, the determining of the adjustment step corresponding to the overshooting cell may include: determining a first cell most affected by overshooting of the overshooting cell from the cell group; and determining the adjustment step corresponding to the overshooting cell according to the cell relationship intimacy degree and the overlap coverage ratio between the overshooting cell and the first cell.

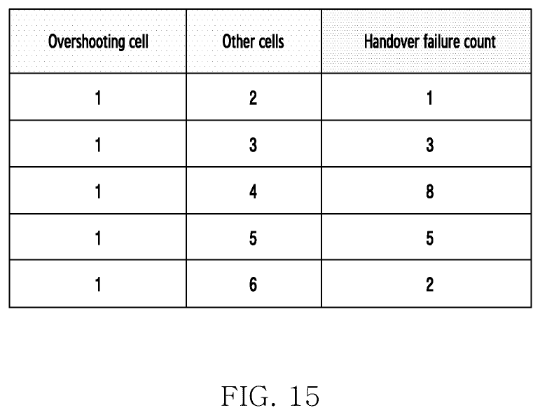

As an example, the first cell most affected by the overshooting of the overshooting cell may be determined among the other cells according to handover information of the overshooting cell and other cells in the cell group. For example, a higher number of handover failures between the overshooting cell and the other cell indicates that the other cell is more affected by the overshooting of the overshooting cell, and thus the first cell may be determined based on the handover information between the overshooting cell and the other cells, wherein the first cell may also be referred to as the worst victim cell of the overshooting cell in the cell group. For example, handover failure counts between the overshooting cell and the other cells in the cell group may be collected, and the first cell may be determined according to the handover failure counts. For example, in cell group 1, the handover failure counts are shown in the table of FIG. 15. The cell that has the largest value of the handover failure count with the overshooting cell is the first cell. For example, in cell group 1, the first cell is cell 4.

After determining the first cell, the adjustment step corresponding to the overshooting cell may be determined according to the relationship intimacy degree and overlap coverage ratio between the overshooting cell and the first cell.

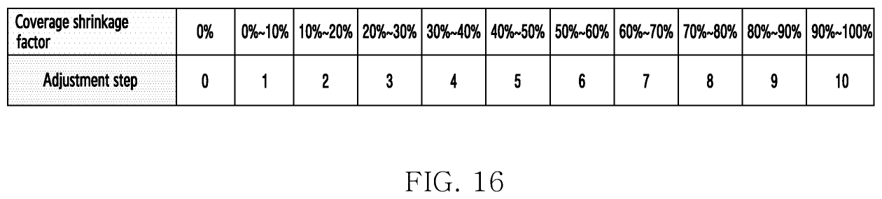

For example, first, a coverage shrinkage factor corresponding to the overshooting cell may be determined according to the cell relationship intimacy degree and overlap coverage ratio between the overshooting cell and the first cell. For example, the coverage shrinkage factor=(α×cell relationship intimacy degree)×(β×overlap coverage ratio), wherein α and β represent weighting factors of the cell relationship intimacy degree and the overlap coverage ratio, respectively, both with an initial value of 1. Subsequently, the adjustment step corresponding to the overshooting cell may be determined according to the coverage shrinkage factor. For example, a mapping relationship between the coverage shrinkage factor and the adjustment step may be established in advance, and according to mapping relationship, after the coverage shrinkage factor is calculated, the corresponding adjustment step may be determined. For example, a mapping table between the coverage shrinkage factor and the adjustment step may be shown in FIG. 16.

It has been described how to determine the adjustment step corresponding to the overshooting cell hereinbefore. As an example, the adjustment step may be the adjustment step of an e-tilt of an antenna in the overshooting cell, or the adjustment step of antenna height, but is not limited to this. In order to address the overshooting problem, the adjustment step corresponding to the overshooting cell being a positive number may refer, for example, to the e-tilt of the antenna being adjusted upward. Referring back to FIG. 5, after determining the adjustment step corresponding to the overshooting cell, the coverage range of the overshooting cell may be adjusted based on the determined adjustment step in step S530. For example, the network node may transmit the determined adjustment step to the base station to control the base station to adjust the coverage range of the overshooting cell based on the received adjustment step. For example, the e-tilt of the antenna or height of the antenna in the overshooting cell may be adjusted in accordance with the determined adjustment step to achieve the adjustment of the coverage range of the overshooting cell.

The method performed by the network node according to the description above has been able to address the problem of overshooting of the overshooting cell. However, as mentioned in problem 3 above, if only the coverage range of the overshooting cell is adjusted, although the overshooting problem of the overshooting cell is addressed, coverage holes may appear between the overshooting cell and other cells, thereby causing frequent call drops for users, destroying the stability of the network, and failing to achieve the global optimization of the overall network. In view of this, the present disclosure further discloses union adjustment of the overshooting to address the above-described problem 3. According to the various embodiments, after constructing the cell group including the overshooting cell, in addition to adjusting the coverage range of the overshooting cell, the above-described method performed by the network node may further include: determining the adjustment steps corresponding to other cells except for the overshooting cell in the cell group; adjusting the coverage ranges of the other cells based on the determined adjustment steps corresponding to the other cells.

According to various embodiments, the determining of the adjustment steps corresponding to the other cells except for the overshooting cell in the cell group may include: determining the adjustment step corresponding to a first cell most affected by overshooting of the overshooting cell in the cell group to a predetermined value; and determining, according to relationship intimacy degree and/or overlap coverage ratios between a second cell among the other cells and cells in the cell group other than the second cell, the adjustment step corresponding to the second cell, wherein the second cell is a cell in the cell group other than the overshooting cell and the first cell. According to various embodiments, the relationship intimacy degree and/or the overlap coverage ratios between the second cell among the other cells and cells in the cell group other than the second cell may include: the relationship intimacy degree and/or the overlap coverage ratio between the second cell and the overshooting cell; and the relationship intimacy degree and/or the overlap coverage ratios between the second cell and cells in the cell group other than the second cell and the overshooting cell.

For example, the adjustment step of the first cell may be determined as 0. Determining the adjustment step of the first cell as 0 indicates that the coverage range of the first cell is not to be adjusted in order to avoid occurrence of a coverage hole.

In order to avoid occurrence of coverage holes and occurrence of new overshooting problems, the adjustment step of the other cells being negative number may refer, for example, to the antenna e-tilt being adjusted downward. For any of the other cells in the cell group other than the overshooting cell and the first cell (hereinafter referred to as the second cell), normalized cell relationship intimacy degree (NormalizedCRID) and a normalized overlap coverage ratio (NormalizedOverlapCoverageRatio) may be calculated, for example, according to the following equations:

$$NormalizedCRID = γ \times {CRID}_{overshootingCell} + ( 1 - γ ) \times \frac{{\sum }_{i = 1}^{{CellNumber}_{cell party} - 2} CRID}{{CellNumber}_{cell party} - 2}$$

Wherein CRID_{overshootingCell} is the relationship intimacy degree between the second cell and the overshooting cell, Σᵢ₌₁^{CellNumber}^{_{cell party}}⁻² CRID is the sum of cell relationship intimacy degree between the second cell and the cells of the cell group other than the second cell and the overshooting cell, CellNumber_{cell party} is the number of cells included in the cell group, and γ is any value between 0 and 1.

$$NormalizedOverlapCoverageRatio = γ \times {OverlapCoverageRatio}_{overshootingCell} + ( 1 - γ ) \times \frac{{\sum }_{i = 1}^{{CellNumber}_{cell party} - 2} OverlapCoverageRatio}{{CellNumber}_{cell party} - 2}$$

Wherein OverlapCoverageRatio_{overshootingCell} is the overlap coverage ratio between the second cell and the overshooting cell, Σᵢ₌₁^{CellNumber}^{_{cell party}}⁻² OverlapCoverageRatio is the sum of the overlap coverage ratios between the second cell and the cells other than the second cell and overshooting cell, CellNumber_{cell party} is the number of cells included in the cell group, and γ is any value between 0 and 1.

After determining the normalized cell relationship intimacy degree and the normalized overlap coverage ratios of the second cell, the coverage shrinkage factor corresponding to the second cell may be calculated in the following manner: coverage shrinkage factor=(α×normalized cell relationship intimacy degree)×(β×normalized overlap coverage ratio), wherein α and β denote weighting factors of the cell relationship intimacy degree and the overlap coverage ratio, respectively. Subsequently, the adjustment step corresponding to the second cell may be determined according to the calculated coverage shrinkage factor corresponding to the second cell. For example, the adjustment step corresponding to the second cell is determined according to the mapping table between the coverage shrinkage factor and the adjustment step as shown in FIG. 16. Since the relationship intimacy degree and/or overlap coverage ratios between the second cell and the cells in the cell group other than the second cell are considered in the calculation of the NormalizedCRID and the NormalizedOverlapCoverageRatio described above, the determined adjustment step corresponding to the second cell takes into account possible impacts on the cells other than the second cell, so that the adjustment of the coverage range of the second cell may avoid new impacts on the other cells, which is conducive to improve the overall stability of the network.

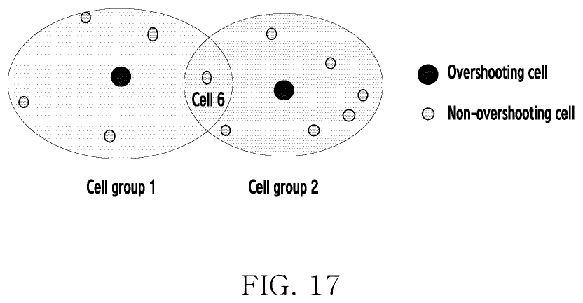

For other cells except for the overshooting cell, there may be cases where the other cell belongs to two cell groups at the same time. For example, as shown in FIG. 17, cell 6 belongs to both cell group 1 and cell group 2. If one cell belongs to two cell groups at the same time, each cell group will determine one adjustment step for it. In order to address the problem of conflicting adjustment steps determined by the cell groups, a final adjustment step may be union-negotiated according to the credibility of the cell groups. The cell group with greater credibility has a higher decision-making power. In this way it is possible to address the problem of overshooting while ensuring the stability of the overall network as much as possible.

To this end, according to various embodiments, the determining of the adjustment steps corresponding to the other cells except for the overshooting cell in the cell group may include: when the other cell belongs to a plurality of cell groups including the cell group at the same time.

If the other cell is a first cell in at least one cell group of the plurality of cell groups, the adjustment step of the other cell is determined as a predetermined value, wherein the first cell is a cell most affected by overshooting of the overshooting cell in the at least one cell group. For example, if the cell is the first cell in the at least one cell group, its union-negotiated adjustment step is determined to be 0.

If the other cell is not the first cell in any of the plurality of cell groups, the adjustment step corresponding to the other cell is determined according to a credibility profile of each cell group among the plurality of cell groups.

According to various embodiments, the credibility profile of each cell group is determined based on relevant network parameters of each cell group.

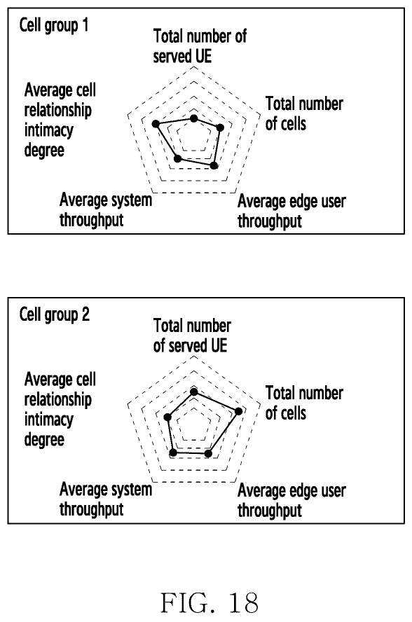

As an example, wherein the relevant network parameters of each cell group may include at least one of an average cell relationship intimacy degree between all cells in each cell group, a total number of served users in each cell group, a total number of cells in each cell group, an average system throughput of each cell group, an average edge user throughput of each cell group. For example, determining the union-negotiated adjustment step for cell 6 in FIG. 17 requires first determining the credibility profiles for cell group 1 and cell group 2, e.g., the determined credibility profiles for cell group 1 and cell group 2 may be as shown in FIG. 18.

After determining the credibility profile of each cell group of the plurality of cell groups to which the other cell belongs at the same time, the adjustment step corresponding to the other cell may be determined according to the credibility profile of each cell group of the plurality of cell groups. For example, the adjustment step corresponding to the other cell determined based on each cell group respectively may be acquired; a credibility of each cell group based on the credibility profile of each cell group is determined; the adjustment step determined based on the cell group with the largest credibility is determined as a final adjustment step corresponding to the other cell. The manner of determining the adjustment steps corresponding to the other cells based on the constructed cell group after the construction of the cell group has been described above, and may not be repeated here. For each cell group, the manner mentioned above may be used to determine the adjustment steps corresponding to the other cells in each cell group. As an example, the determining of the credibility of each cell group based on the credibility profile of each cell group may include: calculating area in a closed loop of the credibility profile of each cell group; determining the credibility of each cell group according to the calculated area. For example, larger area represents a larger credibility of the cell group.

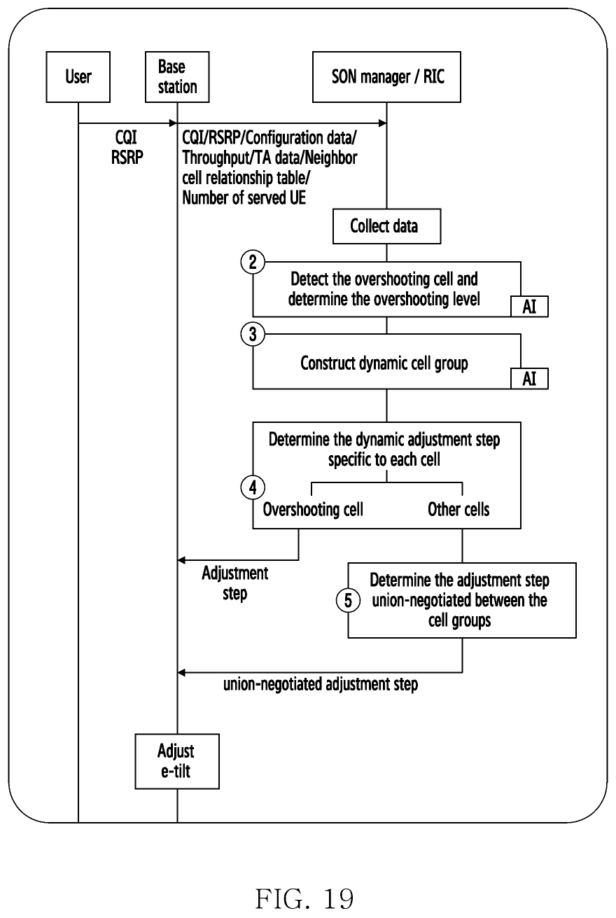

The method performed by the network node according to various embodiments of the present disclosure has been described in detail. For case of understanding, an example of the method performed by the network node according to various embodiments of the present disclosure is briefly summarized below with further reference to FIG. 19.

As shown in FIG. 19, a served user of a base station may report measurement information, e.g., a CQI and an RSRP, to the base station. The base station may transmit the CQI and the RSRP from the served user and configuration data (e.g., antenna configuration data), TA data, a neighbor cell relationship table, a throughput of the cell, the number of users served by the cell, and the like, to the network node, e.g., a SON manager or a RIC. The SON manager or RIC, after collecting such data, may detect the overshooting cell and determine the overshooting level based on the collected data. For example, the AI network may be utilized to detect the overshooting cell and determine the overshooting level. Subsequently, the dynamic cell group may be constructed. For example, the AI network may also be utilized to construct the cell group. After constructing the cell group, the dynamic adjustment step corresponding to each cell in the cell group may be determined. For example, for the overshooting cell, the adjustment step of the overshooting cell may be determined based on the cell relationship intimacy degree and overlap coverage ratio between the overshooting cell and the first cell (e.g., the cell most affected by the overshooting of the overshooting cell). For example, for the first cell, its corresponding adjustment step may be determined as 0, e.g., its coverage range is not adjusted. For example, for other cells, the adjustment step corresponding to that cell may be determined based on the normalized cell relationship intimacy degree and the normalized overlap coverage ratio. When the other cell belongs to a plurality of cell groups at the same time, the adjustment step union-negotiated between the cell groups may be determined based on the credibility profile of each cell group. The specific details of the above mentioned operations have all been described above, and therefore, they will not be repeated here. Finally, after determining the adjustment step corresponding to each cell, the SON manager or the RIC may transmit the determined adjustment step to the base station to control the base station to adjust the e-tilt of the antenna based on the determined adjustment step to realize the adjustment of the coverage range.

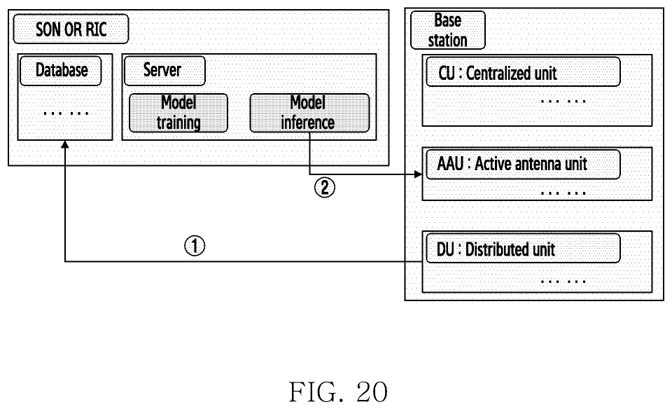

FIG. 20 is a diagram illustrating an example deployment scenario according to various embodiments.

As shown in FIG. 20, training of the various AI networks mentioned above may be implemented in a server in the SON manager or RIC. For example, a distributed unit (DU) of a base station collects data and periodically reports it to the SON manager or RIC for model training. The operations of performing the prediction using the AI network mentioned above (also referred to as “model inference”) may be performed in the server of the SON manager or the RIC. After determining the adjustment step for each cell using the AI network, the SON or RIC may transmit the adjustment step to the active antenna unit (AAU) of the base station, then the AAU may adjust the e-tilt of the antenna to achieve the adjustment of the coverage range of the cell.

It is to be noted that the deployment scenario of the present disclosure embodiment is not limited to the deployment manner shown in FIG. 20, but may be deployed in other manners as needed, for example, if the base station has sufficient computing power, both model training and model inference may also be set to be performed at the base station.

According to various embodiments of the present disclosure, since the dynamic planned coverage range is predicted using artificial intelligence network based on the real-time transmission environment of the cell, and then the overshooting cell is detected based on the actual coverage range and the planned coverage range, the accuracy of the detection of the overshooting cell may be improved. Experiments have shown that the accuracy of detecting the overshooting cell according to various embodiments of the present disclosure is significantly improved compared to always detecting the overshooting cell based on a fixed cell transmission environment. In addition, according to various embodiments of the present disclosure, the actual coverage range may be calculated based on the user location distribution instead of the TA distribution, and thus, the actual coverage range is calculated more accurately, which also improves the accuracy of detecting the overshooting cell, and the overshooting level of the cell may be determined based on the actual coverage range and the planned coverage range, thus realizing the multi-level overshooting detection.

In addition, according to various embodiments of the present disclosure, since the adjustment step corresponding to each cell is determined to adjust the overshooting area of the cell and the adjustment step conflict is handled using the credibility profile, the system throughput is improved. Since the adjustment manner of the various embodiments of the present disclosure not only addresses the overshooting problem, but also avoids occurrence of new coverage holes in the overall network, the throughput of edge users may be improved and the dropped call rate and call blocking rate may be reduced. Experiments have shown that the disclosed embodiments, compared to the prior art, significantly improves both the system throughput and the edge user throughput, and significantly reduces the call drop rate and the call blocking rate.

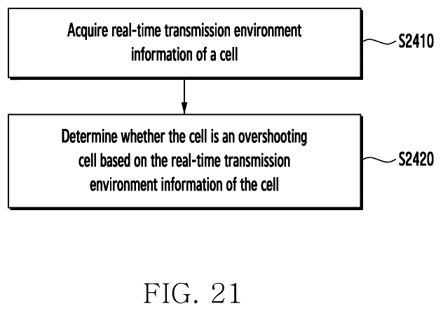

FIG. 21 is a flowchart illustrating an example method performed by a network node according to various embodiments. Referring to FIG. 21, in step S2410, real-time transmission environment information of a cell is acquired. In step S2420, it is determined whether the cell is an overshooting cell based on the real-time transmission environment information of the cell. In the description of various example embodiments above, the content involved in the above steps has been described, and for brevity, may not be repeated here, and the relevant content may be found in the corresponding content above.

According to the method performed by the network node shown in FIG. 21, since it is determined whether the cell is the overshooting cell based on the real-time transmission environment information of the cell, the accuracy of the detection of the overshooting cell may be effectively improved.

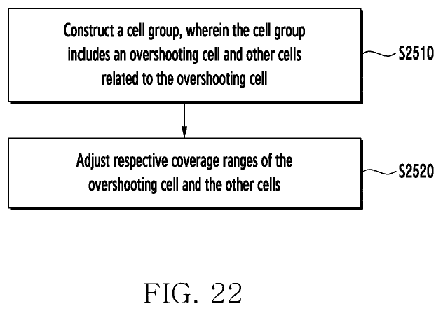

FIG. 22 is a flowchart illustrating an example method performed by a network node according to various embodiments. Referring to FIG. 22, in step S2510, a cell group is constructed, wherein the cell group includes an overshooting cell and other cells related to the overshooting cell. For example, the constructing of the cell group includes: constructing the cell group according to related information between cells. The related information between cells may include at least one of neighbor cell information, handover information, interference information. Examples of how to construct the cell group have been described in the description of various example embodiments above, and may not be repeated here. In step S2520, respective coverage ranges of the overshooting cell and the other cells are adjusted. The method illustrated in FIG. 22 further includes: determining the adjustment step corresponding to the overshooting cell, and determining the adjustment steps corresponding to the other cells. In this case, step S2520 may include: adjusting the coverage range of the overshooting cell based on the adjustment step corresponding to the overshooting cell, and adjusting the coverage ranges of the other cells based on the adjustment steps corresponding to the other cells. How to determine the adjustment step corresponding to the overshooting cell and how to determine the adjustment steps corresponding to other cells in the cell group other than the overshooting cell have been described in the descriptions of various example embodiments above, and relevant examples may be found in the descriptions above, and will not be repeated here. For example, the respective antenna e-tilts may be adjusted based on determining the adjustment steps of the respective antenna e-tilts of the overshooting cell and the other cells, to achieve the adjustment of the respective coverage ranges.

According to the method illustrated in FIG. 22, since after constructing the cell group including the overshooting cell and other cells related to the overshooting cell, in addition to adjusting the coverage range of the overshooting cell, the coverage ranges of the other cells are adjusted, it not only makes the problem of overshooting of the overshooting cell to be addressed, but also facilitates avoiding the occurrence of the coverage hole between the overshooting cell and other cells at the same time, thereby preventing and/or reducing the occurrence of call drops for users, improving the overall stability of the network, and facilitating the realization of the global optimization of the overall network. The method performed by the network node according to various example embodiments of the present disclosure has been described. In the following, a network node according to various embodiments of the present disclosure is briefly described.

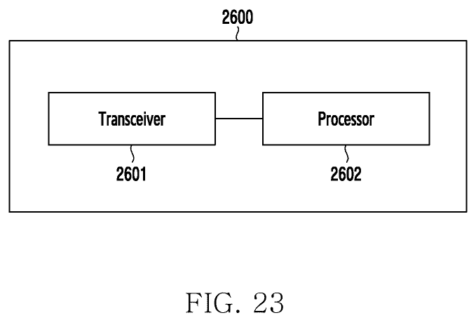

FIG. 23 is a block diagram illustrating an example configuration of a network node according to various embodiments. Referring to FIG. 23, a network node 2600 may include a transceiver (e.g., including communication circuitry) 2601 and a processor (e.g., including processing circuitry) 2602, wherein the processor 2602 is coupled to the transceiver 2601 and configured to perform the method performed by the network node as described above. According to various embodiments, the network node may include a base station, a SON manager, or a RIC, but is not limited thereto.

The various embodiments of the present disclosure also provide an electronic apparatus including at least one processor, which may also include at least one transceiver and/or at least one memory coupled to the at least one processor, the at least one processor is configured to perform the steps of the method provided in any embodiment of the present disclosure.

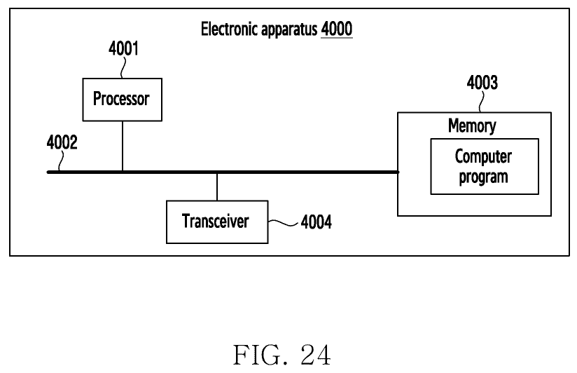

FIG. 24 is a block diagram illustrating an example configuration of an electronic apparatus to which the various embodiments of the present disclosure are applicable according to various embodiments. As shown in FIG. 24, the electronic apparatus 4000 shown in FIG. 24 includes a processor (e.g., including processing circuitry) 4001 and a memory 4003. Wherein, the processor 4001 is connected to the memory 4003, such as through a bus 4002. The electronic apparatus 4000 may further include a transceiver (e.g., including communication circuitry) 4004, which can be used for data interaction between this electronic apparatus and other electronic apparatus, such as data transmission and/or data reception. It should be noted that in practical applications, each of the processor 4001, memory 4003, and transceiver 4004 is not limited to one, and the structure of the electronic apparatus 4000 is not a limitation of the various embodiments of the present disclosure. Alternatively, this electronic apparatus may be a first network node, a second network node, or a third network node.

The processor 4001 can be a CPU (Central Processing Unit), a general-purpose processor, a DSP (Digital Signal Processor), an ASIC (Application Specific Integrated Circuit), an FPGA (Field Programmable Gate Array), or any other programmable logic device, transistor logic device, hardware component, or any combination thereof. It can implement or execute various example logical blocks, modules, and circuits described in conjunction with the content disclosed by the present disclosure. The processor 4001 may also be a combination of computing functions, such as a combination containing one or more microprocessor, a combination of DSP and microprocessor, etc. The processor 4001 according to an embodiment of the disclosure may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The bus 4002 may include a path to transmit information between the aforementioned components. The bus 4002 can be a PCI (Peripheral Component Interconnect) bus or an EISA (Extended Industry Standard Architecture) bus. The bus 4002 can be classified as address bus, data bus, control bus, etc. For ease of representation, only one thick line is used in FIG. 24, but it does not mean that there is only one bus or one type of bus.

The memory 4003 can be ROM (Read Only Memory) or other types of static storage devices that can store static information and instructions, RAM (Random Access Memory) or other types of dynamic storage devices that can store information and instructions, or EEPROM (Electrically Erasable Programmable Read Only Memory), CD-ROM (Compact Disc Read Only Memory) or other disc storage, optical disc storage (including compressed discs, laser discs, optical discs, digital universal discs, Blu-ray discs, etc.), disk storage media, other magnetic storage devices, or any other media that can be used to carry or store computer programs and can be read by a computer, are not limited herein.

The memory 4003 may be used to store computer programs or executable instructions executing the various embodiments of the present disclosure, and the execution is controlled by processor 4001. The processor 4001 is used to execute computer programs or executable instructions stored in memory 4003 to implement the steps shown in the aforementioned method embodiments.

According to an embodiment, a method performed by a network node may comprise detecting an overshooting cell which has an actual coverage range larger than a planned coverage range. The method may comprise determining an adjustment step corresponding to the overshooting cell based on a coverage situation of the overshooting cell. The method may comprise adjusting the actual coverage range of the overshooting cell based on the determined adjustment step.

According to an embodiment, the detecting of the overshooting cell may comprise acquiring real-time transmission environment information of a cell, and determining whether the cell is the overshooting cell based on the real-time transmission environment information of the cell.

According to an embodiment, the acquiring of the real-time transmission environment information of the cell may comprise acquiring cell-related data and/or user-related data, and acquiring the real-time transmission environment information of the cell based on the cell-related data and/or the user-related data.

According to an embodiment, the acquiring of the real-time transmission environmental information of the cell based on the cell-related data and/or the user-related data may comprise acquiring a current user location distribution and a current timing advance (TA) distribution of the cell based on the cell-related data and/or the user-related data, and acquiring the real-time transmission environment information of the cell according to the current user location distribution and the current TA distribution.

According to an embodiment, the cell-related data may comprise at least one of cell configuration information and cell historical TA data, and/or the user-related data may comprise measurement information reported by a served user in the cell.

According to an embodiment, the acquiring of the current user location distribution and the current timing advance (TA) distribution based on the cell-related data and the user-related data may comprise predicting, using a first artificial intelligence network, a historical user location distribution of the cell based on the user-related data and the cell configuration information, and predicting, using a second artificial intelligence network, the current user location distribution based on the historical user location distribution, and predicting, using a third artificial intelligence network, the current TA distribution based on the cell historical TA data.

According to an embodiment, the real-time transmission environment information includes a ratio of line-of-sight (LOS) transmissions and non-line-of-sight (NLOS) transmissions in the cell.

According to an embodiment, the determining of whether the cell is the overshooting cell based on the real-time transmission environment information of the cell may comprise obtaining the actual coverage range of the cell based on a current user location distribution of the cell, obtaining the planned coverage range of the cell based on the real-time transmission environment information, and determining whether the cell is the overshooting cell according to the actual coverage range of the cell and the planned coverage range of the cell.

According to an embodiment, the obtaining of the planned coverage range of the cell based on the real-time transmission environmental information may comprise determining a theoretical coverage range of the cell based on cell related data, and predicting, using a fourth artificial intelligence network, the planned coverage range based on the real-time transmission environmental information and the theoretical coverage range of the cell.

According to an embodiment, the determining of the adjustment step corresponding to the overshooting cell based on the coverage situation of the overshooting cell may comprise determining the adjustment step corresponding to the overshooting cell according to the actual coverage range and the planned coverage range of the overshooting cell.

According to an embodiment, the determining of the adjustment step corresponding to the overshooting cell based on the coverage situation of the overshooting cell may comprise constructing a cell group according to related information between cells, wherein the cell group may comprise the overshooting cell, and determining the adjustment step corresponding to the overshooting cell according to overshooting related information between the overshooting cell and other cells in the cell group.

According to an embodiment, the related information between the cells may comprise at least one of neighbor cell information, handover information, and interference information.

According to an embodiment, the constructing of the cell group according to the related information between the cells may comprise determining relationship intimacy degree between a plurality of cells comprising the overshooting cell according to the related information between the cells, wherein the relationship intimacy degree represents an influence degree between the cells, and constructing the cell group based on the acquired relationship intimacy degree.

According to an embodiment, the determining of the relationship intimacy degree between the plurality of cells comprising the overshooting cell according to the related information between the cells may comprise determining, using a fifth artificial intelligence network, the relationship intimacy degree between the plurality of cells comprising the overshooting cell according to the related information between the cells.

According to an embodiment, the constructing of the cell group based on the acquired relationship intimacy degree may comprise determining an overshooting level of each cell according to the actual coverage range and the planned coverage range of each cell among the plurality of cells, and constructing the cell group based on the determined overshooting level and the acquired relationship intimacy degree.

According to an embodiment, the determining of the overshooting level of each cell according to the actual coverage range and the planned coverage range of each cell among the plurality of cells may comprise predicting, using a sixth artificial intelligence network, the overshooting level of each cell according to the actual coverage range and the planned coverage range of each cell.

According to an embodiment, a method performed by a network node, may comprise acquiring real-time transmission environment information of a cell, and determining whether the cell is an overshooting cell based on the real-time transmission environment information of the cell.

According to an embodiment, a method performed by a network node, may comprise constructing a cell group, wherein the cell group may comprise an overshooting cell and other cells related to the overshooting cell, and adjusting respective coverage ranges of the overshooting cell and the other cells.

According to an embodiment, a network node may comprise a transceiver, at least one processor comprising processing circuitry, and memory comprising one o more storage medium, storing instructions. The instructions, when being executed by at least one processor individually and/or collectively, cause the network node to detect an overshooting cell which has an actual coverage range larger than a planned coverage range, determine an adjustment step corresponding to the overshooting cell based on a coverage situation of the overshooting cell, and adjust the actual coverage range of the overshooting cell based on the determined adjustment step.

According to an embodiment, a non-transitory computer-readable storage medium may store instructions. The instructions, when executed by at least one processor, individually and/or collectively, cause a network node to detect an overshooting cell which has an actual coverage range larger than a planned coverage range, determine an adjustment step corresponding to the overshooting cell based on a coverage situation of the overshooting cell, and adjust the actual coverage range of the overshooting cell based on the determined adjustment step.

According to an embodiment, a method performed by a network node may comprise detecting an overshooting cell, determining an adjustment step corresponding to the overshooting cell based on a coverage situation of the overshooting cell, and adjusting a coverage range of the overshooting cell based on the determined adjustment step.

According to an embodiment, a network node may comprise a transceiver, at least one processor, comprising processing circuitry, coupled to the transceiver, wherein at least one processor, individually and/or collectively, is configured to detect an overshooting cell, determine an adjustment step corresponding to the overshooting cell based on a coverage situation of the overshooting cell, and adjust a coverage range of the overshooting cell based on the determined adjustment step.

In an embodiment of the present disclosure, there is provided a non-transitory computer-readable storage medium storing computer programs or instructions, wherein the computer programs or instructions, when being executed by at least one processor, may execute or implement the steps and corresponding contents of the aforementioned method embodiments.

In an embodiment of the present disclosure, there is further provided a computer program product, including computer programs, when being executed by a processor, may execute or implement the steps and corresponding contents of the aforementioned method embodiments.

The terms “first”, “second”, “third”, “fourth”, “1”, “2” and the like (if exists) in the description and claims of the present disclosure and the above drawings are used to distinguish similar objects, and need not be used to describe a specific order or sequence. It should be understood that data used as such may be interchanged in appropriate situations, so that the various embodiments of the present disclosure described here may be implemented in an order other than the illustration or text description.

For one or more embodiments, at least one of the components set forth in one or more of the preceding figures may be configured to perform one or more operations, techniques, processes, and/or methods as set forth herein. For example, a processor (e.g., baseband processor) as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

The methods according to various embodiments described in the claims and/or the specification of the disclosure may be implemented in hardware, software, or a combination of hardware and software.

When implemented by software, a computer-readable storage medium storing one or more programs (software modules) may be provided. One or more programs stored in such a computer-readable storage medium (e.g., non-transitory storage medium) are configured for execution by one or more processors in an electronic device. The one or more programs include instructions that cause the electronic device to execute the methods according to embodiments described in the claims or specification of the disclosure.

Such a program (e.g., software module, software) may be stored in a random-access memory, a non-volatile memory including a flash memory, a read only memory (ROM), an electrically erasable programmable read only memory (EEPROM), a magnetic disc storage device, a compact disc-ROM (CD-ROM), digital versatile discs (DVDs), other types of optical storage devices, or magnetic cassettes. Alternatively, it may be stored in a memory configured with a combination of some or all of the above. In addition, respective constituent memories may be provided in a multiple number.

Further, the program may be stored in an attachable storage device that can be accessed via a communication network, such as e.g., Internet, Intranet, local area network (LAN), wide area network (WAN), or storage area network (SAN), or a communication network configured with a combination thereof. Such a storage device may access an apparatus performing an embodiment of the disclosure through an external port. Further, a separate storage device on the communication network may be accessed to an apparatus performing an embodiment of the disclosure.

In the above-described specific embodiments of the disclosure, a component included therein may be expressed in a singular or plural form according to a proposed specific embodiment. However, such a singular or plural expression may be selected appropriately for the presented context for the convenience of description, and the disclosure is not limited to the singular form or the plural elements. Therefore, either an element expressed in the plural form may be formed of a singular element, or an element expressed in the singular form may be formed of plural elements.

Meanwhile, specific embodiments have been described in the detailed description of the disclosure, but it goes without saying that various modifications are possible without departing from the scope of the disclosure.

It should be understood that although each operation step is indicated by arrows in the flowcharts of the various embodiments of the present disclosure, an implementation order of these steps is not limited to an order indicated by the arrows. Unless explicitly stated herein, in some implementation scenarios of the various embodiments of the present disclosure, the implementation steps in the flowcharts may be executed in other orders according to requirements. In addition, some or all of the steps in each flowchart may include a plurality of sub steps or stages, based on an actual implementation scenario. Some or all of these sub steps or stages may be executed at the same time, and each sub step or stage in these sub steps or stages may also be executed at different times. In scenarios with different execution times, an execution order of these sub steps or stages may be flexibly configured according to requirements, which is not limited by the various embodiments of the present disclosure.

The above description and drawings are provided as examples only to assist readers in understanding the present disclosure. They are not intended and should not be interpreted as limiting the scope of the present disclosure in any way. Although various example embodiments and examples have been provided, based on the content disclosed herein, it will be apparent to those skilled in the art that changes can be made to the shown embodiments and examples without departing from the scope of the present disclosure. Adopting other similar implementations based on the technical ideas of the present disclosure also fall within the scope of protection of embodiments of the disclosed disclosure. It will also be understood that any of the embodiment(s) described herein may be used in conjunction with any other embodiment(s) described herein.

No claim element is to be construed under the provisions of 35 U.S.C. § 112, sixth paragraph, unless the element is expressly recited using the phrase “means for” or “means.”

What is claimed is:

1. A method performed by a network node comprising:
detecting an overshooting cell which has an actual coverage range larger than a planned coverage range;
determining an adjustment step corresponding to the overshooting cell based on a coverage situation of the overshooting cell; and
adjusting the actual coverage range of the overshooting cell based on the determined adjustment step.

2. The method of claim 1, wherein the detecting of the overshooting cell comprises:
acquiring real-time transmission environment information of a cell; and
determining whether the cell is the overshooting cell based on the real-time transmission environment information of the cell.

3. The method of claim 2, wherein the acquiring of the real-time transmission environment information of the cell comprises:
acquiring cell-related data and/or user-related data; and
acquiring the real-time transmission environment information of the cell based on the cell-related data and/or the user-related data.

4. The method of claim 3, wherein the acquiring of the real-time transmission environmental information of the cell based on the cell-related data and/or the user-related data comprises:
acquiring a current user location distribution and a current timing advance (TA) distribution of the cell based on the cell-related data and/or the user-related data; and
acquiring the real-time transmission environment information of the cell according to the current user location distribution and the current TA distribution.

5. The method of claim 3, wherein the cell-related data comprises at least one of cell configuration information and cell historical TA data; and/or
the user-related data comprises measurement information reported by a served user in the cell.

6. The method of claim 5, wherein the acquiring of the current user location distribution and the current timing advance (TA) distribution based on the cell-related data and the user-related data comprises:
predicting, using a first artificial intelligence network, a historical user location distribution of the cell based on the user-related data and the cell configuration information, and predicting, using a second artificial intelligence network, the current user location distribution based on the historical user location distribution; and
predicting, using a third artificial intelligence network, the current TA distribution based on the cell historical TA data.

7. The method of claim 2, wherein the real-time transmission environment information includes a ratio of line-of-sight (LOS) transmissions and non-line-of-sight (NLOS) transmissions in the cell.

8. The method of claim 2, wherein the determining of whether the cell is the overshooting cell based on the real-time transmission environment information of the cell comprises:
obtaining the actual coverage range of the cell based on a current user location distribution of the cell;
obtaining the planned coverage range of the cell based on the real-time transmission environment information; and
determining whether the cell is the overshooting cell according to the actual coverage range of the cell and the planned coverage range of the cell.

9. The method of claim 8, wherein the obtaining of the planned coverage range of the cell based on the real-time transmission environmental information comprises:
determining a theoretical coverage range of the cell based on cell related data; and
predicting, using a fourth artificial intelligence network, the planned coverage range based on the real-time transmission environmental information and the theoretical coverage range of the cell.

10. The method of claim 1, wherein the determining of the adjustment step corresponding to the overshooting cell based on the coverage situation of the overshooting cell comprises:
determining the adjustment step corresponding to the overshooting cell according to the actual coverage range and the planned coverage range of the overshooting cell.

11. The method of claim 1, wherein the determining of the adjustment step corresponding to the overshooting cell based on the coverage situation of the overshooting cell comprises:
constructing a cell group according to related information between cells, wherein the cell group comprises the overshooting cell; and
determining the adjustment step corresponding to the overshooting cell according to overshooting related information between the overshooting cell and other cells in the cell group.

12. The method of claim 11, wherein the related information between the cells comprises at least one of neighbor cell information, handover information, and interference information.

13. The method of claim 11, wherein the constructing of the cell group according to the related information between the cells comprises:
determining relationship intimacy degree between a plurality of cells comprising the overshooting cell according to the related information between the cells, wherein the relationship intimacy degree represents an influence degree between the cells; and
constructing the cell group based on the acquired relationship intimacy degree.

14. The method of claim 13, wherein the determining of the relationship intimacy degree between the plurality of cells comprising the overshooting cell according to the related information between the cells comprises:
determining, using a fifth artificial intelligence network, the relationship intimacy degree between the plurality of cells comprising the overshooting cell according to the related information between the cells.

15. The method of claim 13, wherein the constructing of the cell group based on the acquired relationship intimacy degree comprises:
determining an overshooting level of each cell according to the actual coverage range and the planned coverage range of each cell among the plurality of cells; and
constructing the cell group based on the determined overshooting level and the acquired relationship intimacy degree.

16. The method of claim 15, wherein the determining of the overshooting level of each cell according to the actual coverage range and the planned coverage range of each cell among the plurality of cells comprises:
predicting, using a sixth artificial intelligence network, the overshooting level of each cell according to the actual coverage range and the planned coverage range of each cell.

17. A network node comprising:
a transceiver;
at least one processor comprising processing circuitry; and
memory comprising one or more storage medium, storing instructions,
wherein the instructions, when being executed by at least one processor individually and/or collectively, cause the network node to:
detect an overshooting cell which has an actual coverage range larger than a planned coverage range;
determine an adjustment step corresponding to the overshooting cell based on a coverage situation of the overshooting cell; and
adjust the actual coverage range of the overshooting cell based on the determined adjustment step.

18. The network node of claim 17, wherein the instructions, when being executed by at least one processor individually and/or collectively, cause the network node to:
acquire real-time transmission environment information of a cell; and
determine whether the cell is the overshooting cell based on the real-time transmission environment information of the cell.

19. The network node of claim 18, wherein the instructions, when being executed by at least one processor individually and/or collectively, cause the network node to:
acquire cell-related data and/or user-related data; and
acquire the real-time transmission environment information of the cell based on the cell-related data and/or the user-related data.

20. A non-transitory computer-readable storage medium storing instructions, the instructions, when executed by at least one processor, individually and/or collectively, cause a network node to:
detect an overshooting cell which has an actual coverage range larger than a planned coverage range;
determine an adjustment step corresponding to the overshooting cell based on a coverage situation of the overshooting cell; and
adjust the actual coverage range of the overshooting cell based on the determined adjustment step.
